(19) United States
(12) Patent Application Publication
(10) Pub. No.: US 2025/0343667 A1
(43) Pub. Date: Nov. 6, 2025

(54) METHOD, USER EQUIPMENT, ACCESS NETWORK NODE

(71) Applicant: NEC Corporation, Minato-ku, Tokyo (JP)

(72) Inventors: Pravjyot DEOGUN, London (GB); Yinan QI, Tokyo (JP)

(73) Assignee: NEC Corporation, Minato-ku, Tokyo (JP)

(21) Appl. No.: 18/867,047

(22) PCT Filed: May 24, 2023
(86) PCT No.: PCT/JP2023/019410

§ 371 Date: Nov. 19, 2024

(30) Foreign Application Priority Data
May 31, 2022 (GB) 2208069.1

(51) Int. Cl. H04L 5/14; H04L 5/00

(52) U.S. Cl. CPC H04L 5/1469; H04L 5/0005; H04L 5/0044

(57) ABSTRACT

A method performed by a user equipment (UE) is disclosed. The method includes: receiving, from an access network node, an indication for indicating at least one time resource, of a plurality of time resources, that is to be used for full duplex communication; determining, based on the indication, resources within the at least one time resource, for which communication is not performed; and adjusting communication with the access network node based on the determining.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive relevance to, improved apparatus and methods that support full duplex communication in time division duplex (TDD) communication bands.

### BACKGROUND ART

Recent developments of the 3GPP standards are referred to as the Long Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’ or ‘base station’) via which communication devices (user equipment or ‘UE’) connect to a core network and communicate to other communication devices or remote servers. For simplicity, the present application will use the term RAN node or base station to refer to any such access nodes.

In the current 5G architecture, for example, the gNB structure may be split into two parts known as the Central Unit (CU) and the Distributed Unit (DU), connected by an F1 interfacee. This enables the use of a ‘split’ architecture, whereby the, typically ‘higher’, CU layers (for example, but not necessarily or exclusively), PDCP) and the, typically ‘lower’, DU layers (for example, but not necessarily or exclusively, RLC/MAC/PHY) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

Historically, communication systems have employed two core duplex schemes-frequency division duplex (FDD) and time division duplex (TDD). In FDD the frequency domain resource is split between downlink (DL) and uplink (UL) whereas in TDD the time domain resource is split between DL and UL.

The appropriate duplex scheme to be used in a given scenario is broadly spectrum dependent, albeit with some overlap. Where lower frequency bands are used for communication, paired spectrum UL and DL resource allocations are generally employed and hence FDD is used. In contrast, for higher frequency bands the use of unpaired spectrum, and hence TDD, is becoming increasingly prevalent. Thus, TDD is widely used in commercial NR deployments. Given the significantly higher carrier frequencies supported by 5G, and that will be supported by future communication generations (6G and beyond) as compared to earlier communication generations, improved techniques for providing efficient use of unpaired spectrum are, and will continue to be, increasingly critical.

However, allocation of too limited a time duration for the UL in TDD carriers has the potential to result in reduced coverage, increased latency, and reduced capacity.

Full duplex (FD) operation, involving sharing both frequency domain and time domain resources between the UL and the DL, within the bandwidth of a conventional TDD carrier, represents one way in which improvements may be achievable over conventional TDD performance. Accordingly, enhancements to implement full duplex operation at the gNB, within TDD carriers, are currently being developed. At present half duplex operation within TDD carriers is still envisaged for the UE, although full duplex UE operation remains an option for the future. The use of FD has, however, the potential to cause serious interference issues, both at the gNB and at the UE, which are difficult to address.

There are a number of possible FD implementations that can be implemented on TDD carriers including, for example, subband non-overlapping, subband overlapping, full overlapping.

Referring to FIGS. 1A to 1D, in subband non-overlapping FD (sometimes referred to as cross division duplex (XDD)), non-overlapping UL, DL and/or TDD specific subbands may be configured (as seen in the general case illustrated in FIG. 1A). As seen in FIGS. 1A to 1D each subband comprises a respective relatively ‘narrow’ frequency band having a bandwidth that extends only part of the full available bandwidth within the current TDD carrier that is configured for communication in the associated cell. A gNB can thus perform simultaneous (full duplex) transmission and reception at the same time, in different respective non-overlapping subbands, for different UEs.

FIG. 1B shows a particular example in which only one dedicated DL subband and one dedicated UL subband are configured in the TDD carrier. FIG. 1C shows an example in which a dedicated UL subband is configured in the middle part of the TDD carrier bandwidth in a manner that overlays (and in effect replaces) the central frequency region of a traditional TDD UL/DL configuration in an effort to reduce the impact of cross-operator interference (because another operator may continue to use the conventional TDD without FD). FIG. 1C shows an example in which a TDD subband is configured, in the middle part of the TDD carrier bandwidth in a manner that overlays (and in effect replaces) the central frequency region of a traditional TDD UL/DL configuration. The central TDD subband, in this example, is deliberately configured to have a complementary UL/DL configuration to the traditional TDD UL/DL configuration that it overlays.

In subband overlapping FD, UL, DL and TDD subbands may be configured in a similar way to subband non-overlapping FD, but the different subbands are allowed to overlap in frequency.

In full overlapping FD the entire available bandwidth may be used for UL or DL transmissions.

Currently, focus is on the development of techniques for implementing subband non-overlapping FD operation and potential related enhancements for dynamic or flexible TDD. It will be appreciated, however, that other FD implementations remain an option for the future and enhancements envisaged for sub-band non-overlapping FD may have benefits in other FD schemes.

Among the interference issues that need to be considered are base station to base station (e.g., inter-gNB) cross link interference (CLI) and UE to UE (inter-UE) CLI.

The inter-gNB CLI may be due, for example, to adjacent-channel CLI, co-channel-CLI (or both) depending on the deployment scenario.

Inter-UE CLI may, for example, comprise CLI arising between UEs in the same cell (intra-cell CLI) as a result of both DL and UL transmissions can running in parallel. In this scenario, interference may be observed by a UE, in the DL, from an adjacent subband which is used for UL transmission from another UE in the same cell. Such interference may, for example, arise due to non-linear distortions or frequency errors (e.g. doppler spread for DL reception). Interference may be expected, in particular, to be apparent for DL frequency resources which are close to UL resource elements (REs). This can become a severe issue when interference is experienced for DL reference signal (RS) reception (e.g., reception of Channel State Information RS (CSI-RS)) which has the potential to reduce system efficiency.

For subband non-overlapping FD operation both in subband (intra-subband) CLI and subband to subband (inter-subband) may be particularly relevant.

### SUMMARY OF INVENTION

### Technical Problem

It can be seen, therefore, that there is a need for enhancements for providing improved CLI handling between the base stations (of the same or different operators) and/or between the UES, to help enable efficient dynamic/flexible TDD in communication networks. Such enhancements will, ideally, provide an appropriate balance of the general requirements of low latency, improved capacity, support for dynamic FD configuration change, reduced/minimised CLI, and support for interworking with legacy (e.g., legacy NR) UEs and base stations.

The disclosure aims to provide apparatus and methods that at least partially address the above needs and/or issues.

### Solution to Problem

In one aspect the disclosure provides a method performed by a user equipment (UE), the method comprising: receiving, from an access network node: first information indicating, for a plurality of time resources, at least one of: which time resources of the plurality of time resources are configured for uplink communication, and which time resources of the plurality of time resources are configured for downlink communication; and second information for configuring communication, in the plurality of time resources, in a first frequency region; configuring, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and communicating with the access network node in the first operational bandwidth of the first frequency region for each of the plurality of time resources.

The second information may include information indicating the at least one time resource, of the plurality of time resources, for which the first operational bandwidth of the first frequency region is to be reduced. The second information may include information indicating at least one of: that the first operational bandwidth of at least one time resource is to be reduced from a higher frequency part of the first frequency region; that the first operational bandwidth of the at least one time resource is to be reduced from a lower frequency part of the first frequency region; or that the first operational bandwidth of the at least one time resource is to be reduced both from the higher frequency part of the first frequency region and the lower frequency part of the first frequency region. The second information may identify at least one time resource, of the plurality of time resources, that is to be used for full duplex communication.

The configuring may include configuring a reduced bandwidth, for at least one time resource that the second information indicates is to be used for full duplex communication, relative to the first operational bandwidth of the first frequency region for at least one other time resource of the plurality of time resources. The second information may configure at least one time resource of the plurality of time resources for downlink communication, and, in a case where the first information indicates that the at least one time resource of the plurality of time resources that the second information configures for downlink communication is configured for uplink communication, the configuring may include configuring a reduced bandwidth relative to the first operational bandwidth of the first frequency region for at least one other time resource of the plurality of time resources.

The second information may configure at least one time resource of the plurality of time resources for uplink communication, and, in a case where the first information indicates that the at least one time resource of the plurality of time resources that the second information configures for uplink communication is configured for downlink communication, the configuring may include configuring a reduced bandwidth relative to the first operational bandwidth of the first frequency region for at least one other time resource of the plurality of time resources. The second information may configure at least one time resource of the plurality of time resources for downlink communication in the first frequency region and for uplink communication in the corresponding second frequency region, and, the configuring may include configuring the bandwidth of both the first frequency region and the corresponding second frequency region to provide, for the corresponding time resource of the plurality of time resources configured for downlink communication in the first frequency region and for uplink communication in the corresponding second frequency region, the at least one frequency gap part corresponding to the first operational bandwidth of the first frequency region and the second operational bandwidth of the corresponding second frequency region.

The configuring may be performed by reducing the first operational bandwidth of the first frequency region, for at least one time resource of the plurality of time resources, at both a higher frequency edge and a lower frequency edge of the first frequency region.

The second information may indicate a size of the at least one frequency gap part that is to be provided by the configuring the bandwidth, or an amount by which the first operational bandwidth of the first frequency region is to be reduced. The second information may provide a resource allocation for a time resource of the plurality of time resources, and the configuring may include configuring a reduced bandwidth for the time resource for which the resource allocation is provided depending on the first information.

In a case where the resource allocation is an uplink resource allocation and the first information indicates the time resource for which the resource allocation is provided is configured for downlink communication, the configuring may include configuring the reduced bandwidth for the time resource for which the resource allocation is provided, relative to the first operational bandwidth of the first frequency region for at least one other time resource of the plurality of time resources; and in a case where the resource allocation is a downlink resource allocation and the first information indicates the time resource for which the resource allocation is provided is configured for uplink communication, the configuring may include configuring the reduced bandwidth for the time resource for which the resource allocation is provided, relative to the first operational bandwidth of the first frequency region for at least one other time resource of the plurality of time resources.

In a case where the first information does not indicate that a time resource for which the resource allocation is provided is configured either for downlink or for uplink communication, the configuring may include configuring the reduced bandwidth for the time resource for which the resource allocation is provided, relative to the first operational bandwidth of the first frequency region for at least one other time resource of the plurality of time resources.

The second information may include third information indicating a frequency configuration of the first frequency region that is to be applied to provide the at least one frequency gap part corresponding to the first operational bandwidth of the first frequency region and the second operational bandwidth of the corresponding second frequency region. The third information may indicate a different frequency configuration is to be applied for time resources that are configured for uplink communication, than for time resources that are configured for downlink communication.

In one aspect the disclosure provides a method performed by a user equipment (UE), the method comprising: receiving, from an access network node: signalling including indication information for indicating at least one time resource, of a plurality of time resources, that is to be used for full duplex communication; determining, based on the indication information, resources within the at least one time resource that is to be used for full duplex communication, for which at least part of at least one uplink transmission is not to take place, or for which at least part of at least one downlink transmission will not be transmitted; and communicating with the access network node based on the determining.

The signalling may include information indicating at least one frequency gap part that is to be applied to a frequency region to be used for uplink communication and a frequency region to be used for downlink communication. The signalling may include beam information indicating at least one beam for which uplink transmission is not to take place, or where at least part of at least one downlink transmission will not be transmitted.

The determining may include determining, based on the indication information, resources within the at least one time resource that is to be used for full duplex communication, in which at least one semi-static uplink transmission is not to take place, or where at least one semi-static downlink transmission will not be transmitted. The determining may include determining, based on the indication information, resources within the at least one time resource that is to be used for full duplex communication, in which at least one dynamic uplink transmission is not to take place, or where at least one dynamic downlink transmission will not be transmitted.

The method may further comprise receiving semi-static signalling configuration information for configuring semi-static signalling, wherein the determining includes determining, based on the semi-static signalling configuration information, that at least one dynamic uplink transmission is not to take place during at least part of at least one downlink semi-static signalling occasion that occurs within the at least one time resource that is to be used for full duplex communication, or that at least one dynamic downlink transmission is not to take place during at least part of at least one uplink semi-static signalling occasion that occurs within the at least one time resource that is to be used for full duplex communication.

The method may further comprise receiving, from the access network node, rate-matching resource information indicating rate-matching resources around which rate-matching of the dynamic uplink transmission, or the dynamic downlink transmission, is to be performed.

The method may further comprise: receiving semi-static signalling configuration information for configuring semi-static signalling, wherein the determining may include determining, based on the semi-static signalling configuration information: that at least one dynamic uplink transmission is not to take place during at least part of at least one downlink semi-static signalling occasion that occurs within the at least one time resource that is to be used for full duplex communication, or that at least one dynamic downlink transmission is not to take place during at least part of at least one uplink semi-static signalling occasion that occurs within the at least one time resource that is to be used for full duplex communication.

The method may further comprise receiving, from the access network node, rate-matching resource information indicating rate-matching resources around which rate-matching of the dynamic uplink transmission, or the dynamic downlink transmission, is to be performed. The rate-matching resource information may indicate time resources in which a rate matching pattern is to be applied. The rate-matching resource information may identify a different respective rate matching pattern for each of a plurality of transmission configuration indicator (TCI) states, or for each of a plurality of downlink beams. The rate-matching resource information may indicate at least one downlink semi-static signalling resource configuration where uplink rate matching is to be performed, or at least one uplink semi-static signalling resource configuration where downlink rate matching is to be performed.

The determining may include determining that at least part of at least one uplink transmission is not to take place in a time resource that is to be used for full duplex communication, or that at least one part of at least downlink transmission will not be transmitted in a time resource that is to be used for full duplex communication. The indication information may indicate a time resource is to be used for full duplex communication by indicating that the time resource includes both uplink and downlink information.

The method may further comprise receiving time resource configuration information indicating, for the plurality of time resources, which time resources of the plurality of time resources are configured for uplink communication and which time resources of the plurality of time resources are configured for downlink communication.

The indication information may indicate a time resource is to be used for full duplex communication: by indicating that the time resource is an uplink time resource in a case where that time resource is indicated to be configured for downlink communication by the time resource configuration information; and by indicating that the time resource is a downlink time resource in a case where that time resource is indicated to be configured for uplink communication by the time resource configuration information.

The determining may include determining, based on the time resource configuration information: that at least part of at least one uplink transmission in a time resource that is to be used for full duplex communication is not to take place unless the time resource configuration information indicates that that time resource is configured for uplink communication, or that at least part of at least one downlink transmission will not be transmitted in a time resource that is to be used for full duplex communication, unless the time resource configuration information indicates that that time resource is configured for downlink communication.

The signalling may include frequency region information identifying a frequency region to be used for uplink communication and a frequency region to be used for downlink communication.

The determining may include determining, based on the frequency region information: that at least part of at least one uplink transmission is not to take place if a resource bandwidth for the at least part of at least one uplink transmission extends beyond a bandwidth of the frequency region to be used for uplink communication, or that at least part of at least one downlink transmission will not be transmitted if a resource bandwidth for the at least part of at least one downlink transmission extends beyond a bandwidth of the frequency region to be used for downlink communication.

The method may further comprise: receiving a plurality of different resource configurations for uplink communication, wherein in a case where the determining includes determining at least part of at least one uplink transmission is not to take place because a resource bandwidth for the at least one uplink transmission extends beyond the bandwidth of the frequency region to be used for uplink communication, the determining may include determining a resource configuration of the plurality of different resource configurations that is within the bandwidth of the frequency region to be used for uplink communication to use for the at least part of at least one uplink transmission.

The signalling may include information indicating at least one frequency gap part that is to be applied to a frequency region to be used for uplink communication and a frequency region to be used for downlink communication. The signalling may include beam information indicating at least one beam for which uplink transmission is not to take place, or where at least part of at least one downlink transmission will not be transmitted. The determining may include determining, based on the beam information: that at least part of at least one uplink transmission is not to take place in a case where the UE is connected to the access network node via a beam for which uplink transmission is not to take place, or that at least part of at least one downlink transmission will not be transmitted in a case where the UE is connected to the access network node via a beam for which downlink transmission will not be transmitted. The determining may include determining: that at least part of at least one uplink transmission is not to take place in a time resource based on a priority of the at least one uplink transmission, or that at least part of at least one downlink transmission will not be transmitted in a time resource based on a priority of the at least part of at least one downlink transmission.

In one aspect the disclosure provides a method performed by a user equipment (UE), the method comprising: receiving, from an access network node, information for indicating a modification to at least one frequency resource allocation for semi-static signalling to be applied in at least one time resource, of a plurality of time resources, that is to be used for full duplex communication; and transmitting or receiving the semi-static signalling, using at least one frequency resource allocation as modified by the modification, in the at least one time resource that is to be used for full duplex communication.

The information for indicating a modification may indicate at least one frequency resource allocation that allocates different frequency resources than frequency resources used for the semi-static signalling in at least one other time resource, of a plurality of time resources.

The at least one frequency resource allocation may include a plurality of frequency regions, and the information for indicating a modification may indicate that at least one frequency region of the plurality of frequency is to be activated or deactivated during the at least one time resource.

In one aspect the disclosure provides a method performed by a user equipment (UE), the method comprising: receiving, from an access network node information for assisting enhanced decoding of downlink information in a first part of a first frequency region compared to a second part of the first frequency region, wherein the first frequency region is configured for downlink communication in at least one time resource that is configured as a full duplex time resource, and wherein the first part of the first frequency region is closer in frequency, than the second part of the first frequency region, to a second frequency region configured for uplink communication in the at least one time resource that is configured as a full duplex time resource; and decoding downlink communication in the first part of the first frequency region and in the second part of the first frequency region, wherein the first part of the first frequency region is decoded based on the information for assisting enhanced decoding of downlink information.

The information for assisting enhanced decoding of downlink information may include a coding rate to be used for downlink communication in the first part of the first frequency region that is different to a coding rate to be used for downlink communication in the second part of the first frequency region. The information for assisting enhanced decoding of downlink information may include information identifying an increased reference signal density in the first part of the first frequency region compared to the second part of the first frequency region. The information for assisting enhanced decoding of downlink information may include information indicating to the UE that degradation of downlink signals is more likely in the first part of the first frequency region compared to the second part of the first frequency region.

Decoding downlink communication in the first part of the first frequency region may include discarding contributions from resource elements based on the information for assisting enhanced decoding of downlink information. Decoding downlink communication in the first part of the first frequency region may include enhancing channel estimates based on the information for assisting enhanced decoding of downlink information.

In one aspect the disclosure provides a user equipment (UE) comprising: means for receiving, from an access network node: first information indicating, for a plurality of time resources, at least one of: which time resources of the plurality of time resources are configured for uplink communication, and which time resources of the plurality of time resources are configured for downlink communication; and second information for configuring communication, in the plurality of time resources, in a first frequency region; and means for configuring, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and means for communicating with the access network node in the first operational bandwidth of the first frequency region for each of the plurality of time resources.

In one aspect the disclosure provides a user equipment (UE) comprising: means for receiving, from an access network node signalling including indication information for indicating at least one time resource, of a plurality of time resources, that is to be used for full duplex communication; means for determining, based on the indication information, resources within the at least one time resource that is to be used for full duplex communication, for which at least part of at least one uplink transmission is not to take place, or for which at least part of at least one downlink transmission will not be transmitted; and means for communicating with the access network node based on the determining.

In one aspect the disclosure provides a user equipment (UE) comprising: means for receiving, from an access network node information for indicating a modification to at least one frequency resource allocation for semi-static signalling to be applied in at least one time resource, of a plurality of time resources, that is to be used for full duplex communication; and means for transmitting or receiving the semi-static signalling, using at least one frequency resource allocation as modified by the modification, in the at least one time resource that is to be used for full duplex communication.

In one aspect the disclosure provides a user equipment (UE) comprising: means for receiving, from an access network node information for assisting enhanced decoding of downlink information in a first part of a first frequency region compared to a second part of the first frequency region, wherein the first frequency region is configured for downlink communication in at least one time resource that is configured as a full duplex time resource, and wherein the first part of the first frequency region is closer in frequency, than the second part of the first frequency region, to a second frequency region configured for uplink communication in the at least one time resource that is configured as a full duplex time resource; and means for decoding downlink communication in the first part of the first frequency region and in the second part of the first frequency region, wherein the first part of the first frequency region is decoded based on the information for assisting enhanced decoding of downlink information.

In one aspect the disclosure provides a method performed by an access network node, the method comprising: transmitting, to a user equipment (UE): first information indicating, for a plurality of time resources, at least one of: which time resources of the plurality of time resources are configured for uplink communication, and which time resources of the plurality of time resources are configured for downlink communication; and second information for configuring communication, in the plurality of time resources, in a first frequency region, wherein the second information includes information for application at the UE to configure, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and communicating with the UE in the first operational bandwidth of the first frequency region for each of the plurality of time resources.

In one aspect the disclosure provides a method performed by an access network node, the method comprising: transmitting, to a user equipment (UE) signalling including indication information for indicating at least one time resource, of a plurality of time resources, that is to be used for full duplex communication, wherein the full duplex indication information includes information for application at the UE to determine, based on the indication information, resources within the at least one time resource that is to be used for full duplex communication, for which at least part of at least one uplink transmission is not to take place, or for which at least part of at least one downlink transmission will not be transmitted; and communicating with the UE based on the full duplex indication information.

In one aspect the disclosure provides a method performed by an access network node, the method comprising: transmitting, to a user equipment (UE) information for indicating a modification to at least one frequency resource allocation for semi-static signalling to be applied in at least one time resource, of a plurality of time resources, that is to be used for full duplex communication; and transmitting or receiving the semi-static signalling, using at least one frequency resource allocation as modified by the modification, in the at least one time resource that is to be used for full duplex communication.

In one aspect the disclosure provides a method performed by an access network node, the method comprising: transmitting, to a user equipment (UE) information for assisting enhanced decoding of downlink information in a first part of a first frequency region compared to a second part of the first frequency region, wherein the first frequency region is configured for downlink communication in at least one time resource that is configured as a full duplex time resource, wherein the first part of the first frequency region is closer in frequency, than the second part of the first frequency region, to a second frequency region configured for uplink communication in the at least one time resource that is configured as a full duplex time resource, and wherein the full duplex indication information includes information for application at the UE to decode downlink communication in the first part of the first frequency region and in the second part of the first frequency region, wherein the first part of the first frequency region is decoded based on the information for assisting enhanced decoding of downlink information.

In one aspect the disclosure provides an access network node comprising: means for transmitting, to a user equipment (UE): first information indicating, for a plurality of time resources, at least one of: which time resources of the plurality of time resources are configured for uplink communication, and which time resources of the plurality of time resources are configured for downlink communication; and second information for configuring communication, in the plurality of time resources, in a first frequency region, wherein the second information includes information for application at the UE to configure, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and means for communicating with the UE in the first operational bandwidth of the first frequency region for each of the plurality of time resources.

In one aspect the disclosure provides an access network node comprising: means for transmitting, to a user equipment (UE) signalling including full duplex indication information for indicating at least one time resource, of a plurality of time resources, that is to be used for full duplex communication, wherein the full duplex indication information includes information for application at the UE to determine, based on the full duplex indication information, resources within the at least one time resource that is to be used for full duplex communication, for which at least part of at least one uplink transmission is not to take place, or for which at least part of at least one downlink transmission will not be transmitted; and means for communicating with the UE based on the full duplex indication information.

In one aspect the disclosure provides an access network node comprising: means for transmitting, to a user equipment (UE) information for indicating a modification to at least one frequency resource allocation for semi-static signalling to be applied in at least one time resource, of a plurality of time resources, that is to be used for full duplex communication; and means for transmitting or receiving the semi-static signalling, using at least one frequency resource allocation as modified by the modification, in the at least one time resource that is to be used for full duplex communication.

In one aspect the disclosure provides an access network node comprising: means for transmitting, to a user equipment (UE) information for assisting enhanced decoding of downlink information in a first part of a first frequency region compared to a second part of the first frequency region, wherein the first frequency region is configured for downlink communication in at least one time resource that is configured as a full duplex time resource, and wherein the first part of the first frequency region is closer in frequency, than the second part of the first frequency region, to a second frequency region configured for uplink communication in the at least one time resource that is configured as a full duplex time resource, and wherein the full duplex indication information includes information for application at the UE to decode downlink communication in the first part of the first frequency region and in the second part of the first frequency region, wherein the first part of the first frequency region is decoded based on the information for assisting enhanced decoding of downlink information.

It will be appreciated that while the communication system to which the present application relates is described in the context of full duplex enhancement at the base station side, half duplex operation at the UE side, and no restriction on the frequency ranges; the enhancements described may have benefit in other communication systems. For example, communication systems in which the UE is capable of full duplex operation and/or there are restrictions on the frequency ranges that may be used.

Example embodiments of the disclosure will now be described, by way of example, with reference to the accompanying drawings in which:

### BRIEF DESCRIPTION OF DRAWINGS

FIG. 1A is a time frequency diagram illustrating a subband non-overlapping full duplex scheme and various exemplary implementations of such a scheme;

FIG. 1B is a time frequency diagram illustrating a subband non-overlapping full duplex scheme and various exemplary implementations of such a scheme;

FIG. 1C is a time frequency diagram illustrating a subband non-overlapping full duplex scheme and various exemplary implementations of such a scheme;

FIG. 1D is a time frequency diagram illustrating a subband non-overlapping full duplex scheme and various exemplary implementations of such a scheme;

FIG. 2 schematically illustrates a mobile (‘cellular’ or ‘wireless’) telecommunication system;

FIG. 3 illustrates a typical frame structure that may be used in the telecommunication system of FIG. 2;

FIG. 4 is a simplified sequence diagram illustrating different slot configuration procedures that can be employed in the telecommunication system of FIG. 2;

FIG. 5 shows illustrative examples of slot configurations configured by the procedures of FIG. 4;

FIG. 6 is a simplified sequence diagram illustrating a full duplex configuration method that can be employed in the telecommunication system of FIG. 2;

FIG. 7 is a simplified time frequency diagram showing an illustrative example of full duplex configuration according to the method of FIG. 6;

FIG. 8 is a simplified sequence diagram illustrating another full duplex configuration method that can be employed in the telecommunication system of FIG. 2;

FIG. 9 is a simplified time frequency diagram showing an illustrative example of full duplex configuration according to the method of FIG. 8;

FIG. 10 is a simplified sequence diagram illustrating a number of different possible interference alleviation/avoidance mechanisms that can be employed in the telecommunication system of FIG. 2;

FIG. 11 is a simplified time frequency diagram showing an illustrative example of a possible frequency gap implementation;

FIG. 12 is a simplified sequence diagram illustrating a number of other possible interference alleviation/avoidance mechanisms that can be employed in the telecommunication system of FIG. 2;

FIG. 13 is a simplified sequence diagram illustrating a possible interference alleviation/avoidance mechanism for semi-static signals/channels that can be employed in the telecommunication system of FIG. 2;

FIG. 14A is a time frequency diagram showing an illustrative example of how pre-emption/reconfiguration may take place for an UL transmission in the telecommunication system of FIG. 2;

FIG. 14B is a time frequency diagram showing an illustrative example of how pre-emption/reconfiguration may take place for an UL transmission in the telecommunication system of FIG. 2;

FIG. 14C is a time frequency diagram showing an illustrative example of how pre-emption/reconfiguration may take place for an UL transmission in the telecommunication system of FIG. 2;

FIG. 15 is a simplified sequence diagram illustrating other possible interference alleviation/avoidance mechanisms for semi-static signals/channels that can be employed in the telecommunication system of FIG. 2;

FIG. 16 is a simplified sequence diagram illustrating a number of possible interference alleviation/avoidance mechanisms for identifying rate matching resources that can be employed in the telecommunication system of FIG. 2;

FIG. 17 is a simplified sequence diagram illustrating a number of possible interference alleviation/avoidance mechanisms for dynamic UL/DL channels that can be employed in the telecommunication system of FIG. 2;

FIG. 18A is a time frequency diagram showing an illustrative example of how resources may be identified for pre-empted dynamic transmissions in the telecommunication system of FIG. 2;

FIG. 18B is a time frequency diagram showing an illustrative example of how resources may be identified for pre-empted dynamic transmissions in the telecommunication system of FIG. 2;

FIG. 18C is a time frequency diagram showing an illustrative example of how resources may be identified for pre-empted dynamic transmissions in the telecommunication system of FIG. 2;

FIG. 19 is a simplified sequence diagram illustrating a number of possible interference alleviation/avoidance mechanisms based on robust decoding of the downlink that can be employed in the telecommunication system of FIG. 2;

FIG. 20 is a simplified sequence diagram illustrating a number of possible interference alleviation/avoidance mechanisms based on proactive compensation for downlink degradation that can be employed in the telecommunication system of FIG. 2;

FIG. 21 is a schematic block diagram illustrating the main components of a UE or the telecommunication system of FIG. 2; and

FIG. 22 is a schematic block diagram illustrating the main components of the base station for the telecommunication system of FIG. 2.

### DESCRIPTION OF EMBODIMENTS

### Overview

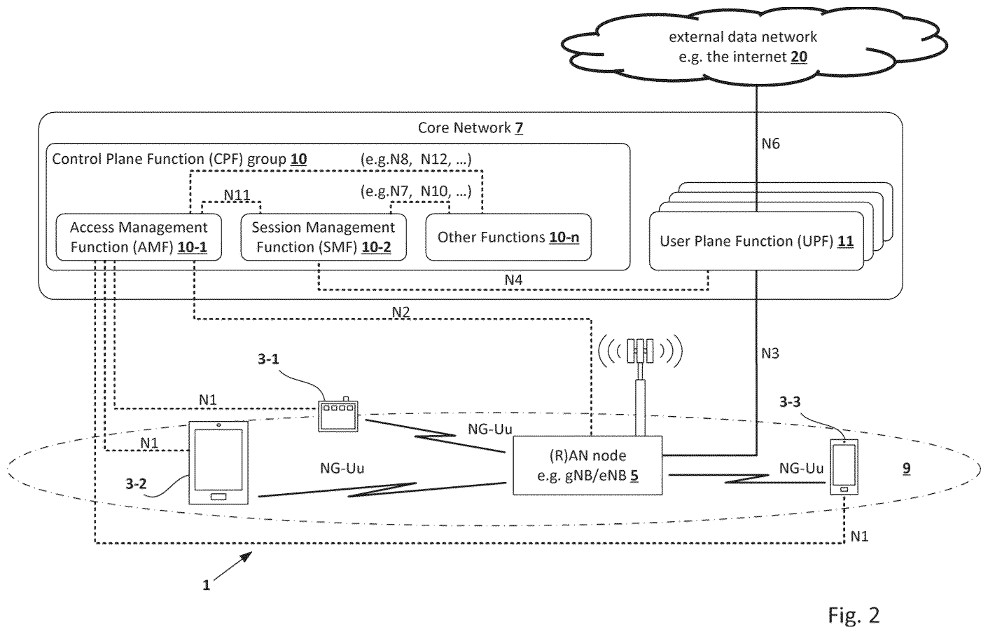

An exemplary telecommunication system will now be described, by way of example only, with reference to FIGS. 2 to 9.

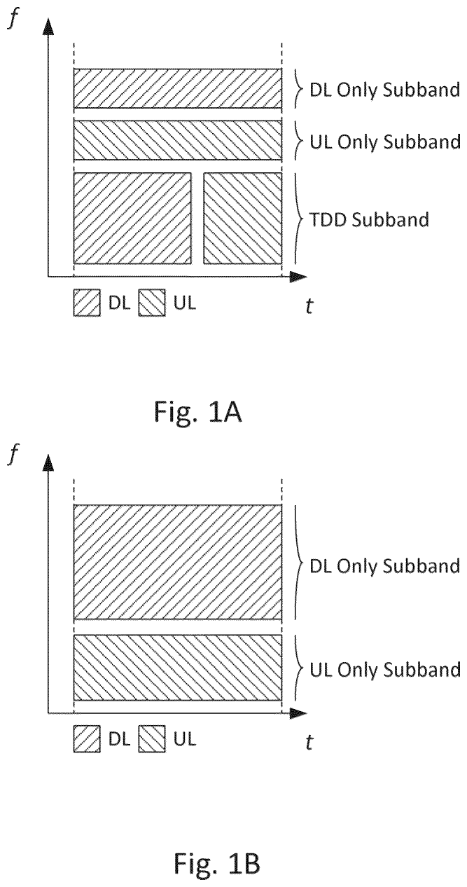

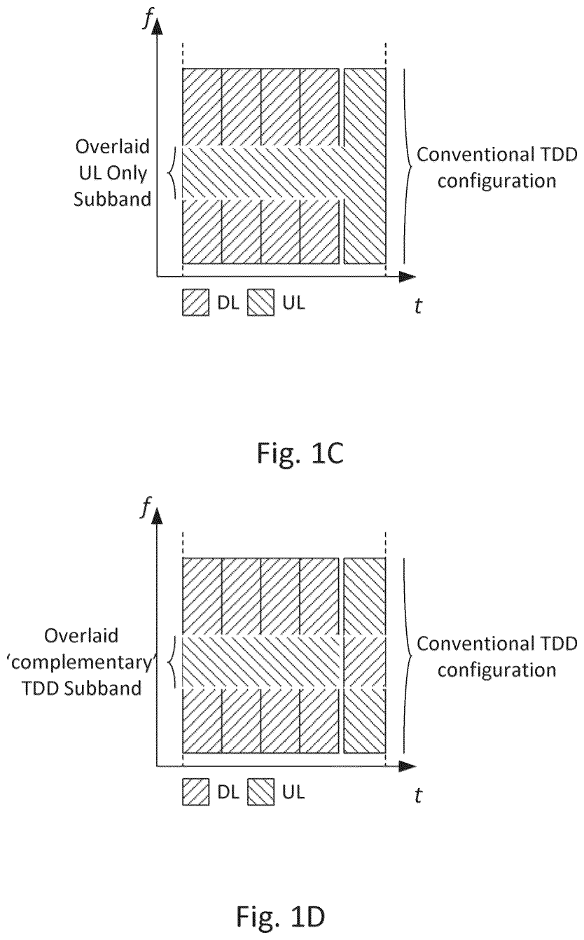

FIGS. 1A to 1D schematically illustrate a mobile (‘cellular’ or ‘wireless’) telecommunication system 1 to which example embodiments of the present disclosure are applicable.

In the network 1 user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIGS. 1A to 1D for illustration purposes, the system, when implemented, will typically include other base stations and UEs.

Each base station 5 controls the associated cell(s) 9 either directly, or indirectly via one or more other nodes (such as home base stations, relays, remote radio heads, distributed units, and/or the like). It will be appreciated that the base stations 5 may be configured to support both 4G and 5G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

The UPF(s) 11 are connected to an external data network (e.g. an IP network such as the internet) via reference point N6 for communication of the user data.

The AMF 10-1 performs mobility management related functions, maintains the non-NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

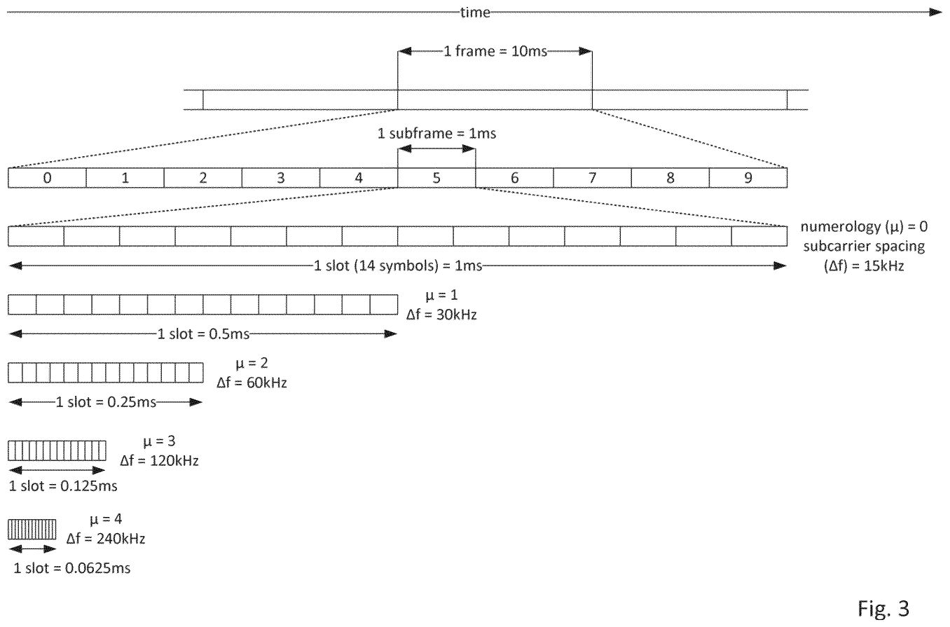

Referring to FIG. 3, which illustrates the typical frame structure that may be used in the telecommunication system 1, the base station 5 and UEs 3 of the telecommunication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 3, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2^{μ} kHz). The relationship between the parameter, μ, and SCS (Δf) is as shown in Table 1:

TABLE 1
5G Numerology

| | Δf = | Number of slots | Slot length |
|---|---|---|---|
| μ | 2^{μ} · 15 [kHz] | per subframe | (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### Slot Configuration

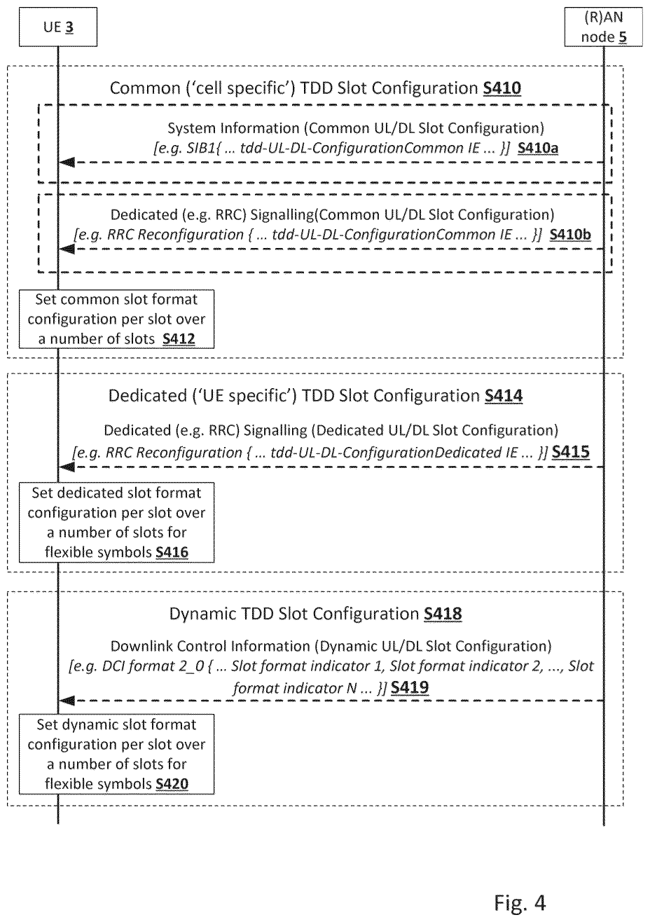

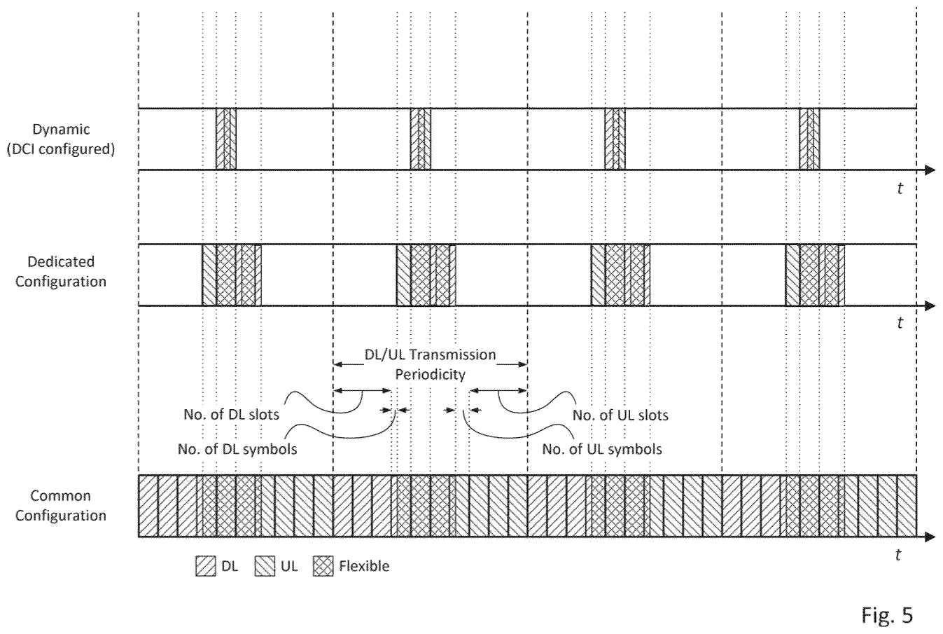

Referring to FIGS. 4 and 5 the base station 5 configures the slot usage within each cell 9 operated on a TDD carrier appropriately.

As seen in FIG. 4, which is a simplified sequence diagram illustrating different slot configuration procedures (S410, S414, S418) that can be employed in the communication system 1, the base station 5 is capable of employing a number of different procedures for configuring slot usage in each cell 9 operated on the TDD carrier.

As seen in procedure S410, for example, the base station 5 of the communication system 1 is configured for providing a respective common (or ‘cell specific’) slot configuration, for each cell 9 operated on a TDD carrier. This common slot configuration can be provided using system information (as illustrated at S410a) to all UEs 3 within the cell (for example in a tdd-UL-DL-ConfigurationCommon information element (IE) of system information block type 1 (SIB1)). This common slot configuration can also be provided using dedicated (e.g., radio resource control (RRC)) signalling (as illustrated at S410b) to specific UEs 3 within the cell (for example in a tdd-UL-DL-ConfigurationCommon IE of an RRC message such as an RRC reconfiguration message or the like). On receipt of the common slot configuration a UE 3 can thus set a common slot format configuration per slot over a number of slots (as seen at S412).

As seen in FIG. 5, which shows illustrative examples of slot configurations configured by the procedures of FIG. 4, the slots may be configured as downlink only slots, as uplink only slots, or as unallocated or ‘flexible’ slots (that may be downlink or uplink).

The common slot configuration is defined by a number of parameters provided by the base station 5 as part of the common UL/DL configuration. These parameters include: a slot configuration period (e.g., configured by a dl-UL-TransmissionPeriodicity IE); a number of slots with only downlink symbols (e.g., configured by a nrofDownlinkSlots IE); a number of downlink symbols (e.g., configured by a nrofDownlinkSymbols IE); a number of slots with only uplink symbols (e.g., configured by a nrofUplinkSlots IE); and a number of uplink symbols (e.g., configured by a nrofUplinkSymbols IE). As seen in FIG. 5, these effectively configure a repeating pattern of slot types (repeating at the slot configuration period), which in this example comprises DL only slots and symbols, followed by flexible slots and symbols, followed by UL only slots and symbols. The repeating pattern starts with a DL group comprising the defined number of DL only slots followed by the defined number of DL only symbols in the next slot. The repeating pattern ends with a UL group comprising the defined number of UL only slots preceded by the defined number of UL only symbols in the preceding slot. The flexible symbols and slots are those, between the DL group of DL only slots and symbols and the UL group of UL only slots and symbols.

As seen in procedure S414, the base station 5 of the communication system 1 is also configured for providing, if required, a dedicated (or ‘UE specific’) slot configuration for a specific UE 3. This dedicated slot configuration can be provided using dedicated (e.g., radio resource control (RRC)) signalling (as illustrated at S415) to a specific UE 3 within the cell (for example in a tdd-UL-DL-ConfigurationDedicated IE of an RRC message such as an RRC reconfiguration message or the like).

If a UE 3 is provided with the dedicated slot configuration in addition to the common slot configuration, then the dedicated slot configuration overrides only the symbols and slots configured as flexible symbols and slots, per slot, over the number of slots configured by the common slot configuration (as seen in the example of FIG. 5).

The dedicated configuration, if provided, includes individual slot specific configuration(s) (e.g., using a slotSpecificConfigurationsToAddModList IE) in which each slot configuration contains information (e.g., a slotindex IE) identifying a specific slot within the slot configuration period defined by the common slot configuration, and information defining a symbol structure (e.g., a symbols IE). The information defining the symbol structure provides the direction (downlink or uplink) for the symbols within the specific slot that is being configured. The information defining the symbols structure may, for example: indicate that all symbols in the specific slot are used for the downlink (e.g., by setting the symbols IE to ‘allDownlink’); indicate that all symbols in the specific slot are used for the uplink (e.g., by setting the symbols IE to ‘allUplink’); or explicitly indicate how many symbols at the beginning and the end of the specific slot are allocated to downlink and uplink, respectively (e.g., a nrofDownlinkSymbols IE may indicate the number of consecutive downlink symbols in the beginning of the slot identified by the slot index, and a nrofUplinkSymbols IE may indicate the number of consecutive uplink symbols at the end of the slot identified by the slot index).

A UE 3 can thus set a dedicated slot format configuration per slot over a number of slots (as seen at S416).

A UE 3 thus teats symbols in a slot indicated as downlink by the common slot configuration, or the dedicated slot configuration to be available for receptions. Similarly a UE 3 teats symbols in a slot indicated as uplink by the common slot configuration, or the dedicated slot configuration to be available for transmissions.

Even after the slot configurations in a cell-specific and UE-specific manner described above, the slot configuration may have some more flexible slots/symbols left unallocated. By making use of layer 1 signalling, the remaining (if any) flexible symbols can dynamically be reconfigured.

As seen in procedure S418, for example, the base station 5 of the communication system 1 is also configured for providing one or more dynamic slot configurations to a group of one or more UEs 3 by means of a physical downlink control channel (PDCCH). The dynamic slot configuration(s) can be provided using downlink control information using an appropriate DCI format (e.g., DCI format 2_0), as illustrated at S419, to a specific group of one or more UEs 3 within the cell 9.

Indexes of one or more slot format indicators (SFIs) are provided within the payload of the DCI for the group of one or more UEs 3. To allow the DCI to be addressed to, and decoded by, the UE(s) 3 of the group cyclic redundancy check (CRC) bits of the DCI are scrambled with an associated radio network temporary identifier (RNTI), for example an ‘SFI-RNTI’ and the UE(s) in the group are allocated with the same RNTI. Each UE 3 of the group is configured to extract its own SFI-index based on the position of the SFI-index within the DCI payload (this position may, for example, be configured by UE specific RRC signalling). The RRC configuration may, for example, be by means of an RRC message carrying a PDCCH serving cell configuration IE having a slot format indicator (SFI) IE that, for a specific serving cell (identified by a serving cell ID (e.g., by a servingCellId IE)): provides an SFI-RNTI; defines one or more slot format combinations (e.g., by a slotFormatCombinations IE); and specifies the starting position (bit), in the DCI, of the SFI index that is applicable for the configured UE (e.g., by a positionInDCI IE).

Each SFI-index provided by the DCI acts as a pointer to a combination of slot formats (where each slot format corresponds to a respective combination of downlink, uplink, and/or flexible symbols) for defining a slot format for each slot in a number of slots starting from a slot where the UE detects the dynamic slot configuration DCI format.

Thus, for any slot indicated to a UE as flexible by both a common slot configuration and a dedicated slot configuration, the DCI can be used to dynamically configure downlink, uplink, and/or flexible symbols within that slot (as seen in the example of FIG. 5).

A UE 3 can thus set a dynamic slot format configuration per slot over a number of slots (as seen at S420).

Generally, for a set of symbols of a slot indicated to a UE 3 as flexible by the common slot configuration and the dedicated slot configuration (if provided), if the UE detects a DCI format for dynamically configuring a format for that slot:
if an SFI-index field value in the received DCI indicates the set of symbols of the slot as flexible, and the UE does not detect a DCI format indicating to the UE to receive a physical downlink shared channel (PDSCH) or CSI-RS, or the UE does not detect a DCI format, a random access response (RAR) UL grant, fallback RAR UL grant, or a successful RAR indication indicating to the UE to transmit a physical uplink shared channel (PUSCH), a physical uplink control channel (PUCCH), a physical random access channel (PRACH), or sounding reference signal(s) (SRS) in the set of symbols of the slot, then the UE does not transmit or receive in the set of symbols of the slot;
if the UE is configured by higher layers to receive PDSCH or CSI-RS in the set of symbols of the slot, the UE receives the PDSCH or the CSI-RS in the set of symbols of the slot only if an SFI-index field value in the received DCI indicates the set of symbols of the slot as downlink; and
if the UE is configured by higher layers to transmit PUCCH, or PUSCH, or PRACH in the set of symbols of the slot, the UE transmits the PUCCH, or the PUSCH, or the PRACH in the slot only if an SFI-index field value in the received DCI indicates the set of symbols of the slot as uplink.

Generally, if a UE 3 is not configured to monitor PDCCH for a DCI format for dynamically configuring the slot format then, for a set of symbols of a slot that are indicated as flexible by a common slot configuration and a dedicated slot configuration (if provided):
the UE receives PDSCH or CSI-RS in the set of symbols of the slot if the UE receives a corresponding indication by a DCI format;
the UE transmits PUSCH, PUCCH, PRACH, or SRS in the set of symbols of the slot if the UE receives a corresponding indication by a DCI format, a RAR UL grant, fallback RAR UL grant, or successful RAR indication;
a symbol is configured as uplink, if the symbol is flexible and the UE is configured to transmit SRS, PUCCH, PUSCH, or PRACH on the symbol; and
a symbol is configured as downlink, if the symbol is flexible and the UE is configured to receive PDCCH, PDSCH or CSI-RS on the symbol.

It can be seen, therefore, that cell specific, UE dedicated, and dynamic methods are provided for TDD frame structure signalling. Full duplex can, therefore, potentially be achieved by signalling different TDD frame structures (slot configurations) for different UEs. However, simply signalling different TDD frame structures in this manner would mean that the UE-to-UE differences would not be visible to individual UEs, and each UE would effectively assume that an entire cell bandwidth is available for a DL or UL physical layer procedure (albeit not both at the same time).

It can also be seen that interpretation of flexible slots by a UE is conventionally dependent on whether the UE is configured to receive DCI, having a dynamic slot configuration DCI format, by RRC. When a dynamic slot configuration DCI format is not configured for a UE, then that UE would (in the absence of configuration to the contrary) assume that configured DL and UL transmission are still valid over flexible slots. Otherwise, the UE would only be able to initiate UL and DL in flexible slots if indicated by DCI.

### Bandwidth Parts (BWPs)

In the communication system 1 the cell bandwidth can be divided into multiple bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. It will be appreciated that conventionally the number of downlink symbols, uplink symbols, and flexible symbols in each slot of the slot configuration (e.g., common or dedicated) would be common to each configured BWP.

The UEs 3 and base station 5 of the communication system 1 are thus configured for operation using BWPs. For each serving cell of a UE 3, the base station 5 can configure at least one downlink (DL) BWP (e.g. an initial DL BWP). The base station 5 may configure the UE 3 with up to a maximum (typically four) DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g. an initial UL BWP). The base station 5 may configure the UE 3 with up to a maximum (typically four) UL BWPs with only one UL BWP being active at a given time. The UE 3 does not transmit PUSCH or PUCCH outside an active bandwidth part. For an active cell, the UE 3 does not transmit SRS outside an active bandwidth part. It will be appreciated that the slot format indicator (e.g., an SFI-index field value) in the dynamic slot configuration DCI format may indicate to a UE 3 a slot format for each slot in a number of slots for each DL BWP or each UL BWP.

A BWP identifier or index (BWP-ID) is used to refer to BWPs (in UL and DL independently). Various radio resource control (RRC) configuration procedures can thus use the BWP-ID to associate themselves with a particular BWP.

While for paired spectrum (FDD), DL BWPs and UL BWPs are configured separately, for unpaired spectrum (TDD), a DL BWP is effectively linked to (paired with) a UL BWP, with the paired DL BWP and UL BWP sharing the same BWP-ID and centre frequency (but possibly different bandwidths).

Specifically, the base station 5 is able to configure an initial DL BWP (e.g. by means of an initialDownlinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for the initial DL BWP may be provided via system information whereas UE specific parameters may be provided via dedicated signalling (e.g. in a ServingCellConfig 1E within an RRC message that contains a dedicated, UE-specific, BWP configuration). The dedicated signalling may also contain some cell-specific information which may be useful for specific scenarios (e.g. handover).

The base station 5 is able to configure an initial UL BWP (e.g. by means of an initialUplinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for the initial UL BWP(s) may be provided via system information whereas UE specific parameters may be provided via dedicated signalling (e.g. in a ServingCellConfig 1E within an RRC message that contains a dedicated, UE-specific, BWP configuration). This provides configuration information either for a so-called special cell (SpCell)—which is a PCell of a master cell group (MCG) or secondary cell group (SCG)—or a secondary cell (SCell).

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g. CORESET #0-defined by a master information block (MIB) (or possibly dedicated RRC signalling). The CORESET is used to carry downlink control information (DCI) transmitted via a physical downlink control channel (PDCCH) for scheduling system information blocks.

After receiving the system information (e.g. SIB1) a UE 3 uses the BWP configuration defined by that system information to configure the initial DL BWP and initial UL BWP. The configured initial UL BWP is then used to initiate a random-access procedure for setting up an RRC connection. The base station 5 configures the frequency domain location and bandwidth of the initial DL BWP in the system information so that the initial DL BWP contains the entire CORESET #0 in the frequency domain.

For each DL BWP in a set of DL BWPs for a primary cell, a UE 3 can be configured with CORESETs for every type of common search space (CSS) set and for a UE-specific search space (USS) set. For each UL BWP in a set of UL BWPs of a primary cell, or of a PUCCH-secondary cell, the UE 3 is configured resource sets for PUCCH transmissions.

The UE 3 is configured for switching its active BWP between its configured BWPs when required. For example, switching at the UE 3 may be initiated by receipt of a scheduling DCI, by expiry of an inactivity timer (e.g., a BWPInactivity Timer), and/or by initiation of a random-access procedure.

### Achieving Full Duplex

Beneficially, the UEs 3 and base station 5 of the communication system 1 are mutually configured for providing full duplex (FD) communication on a TDD carrier. Specifically, the UEs 3 and base station 5 of the communication system 1 are configured to facilitate subband non-overlapping FD communication.

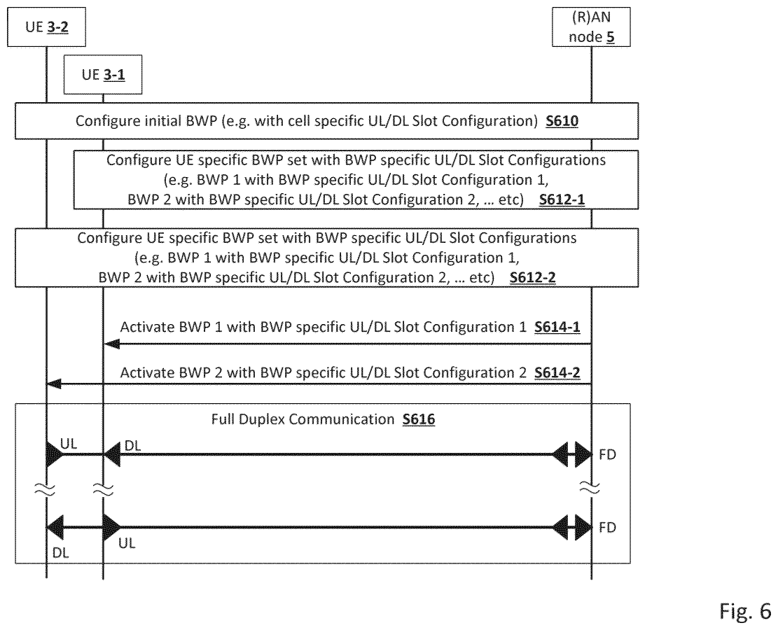

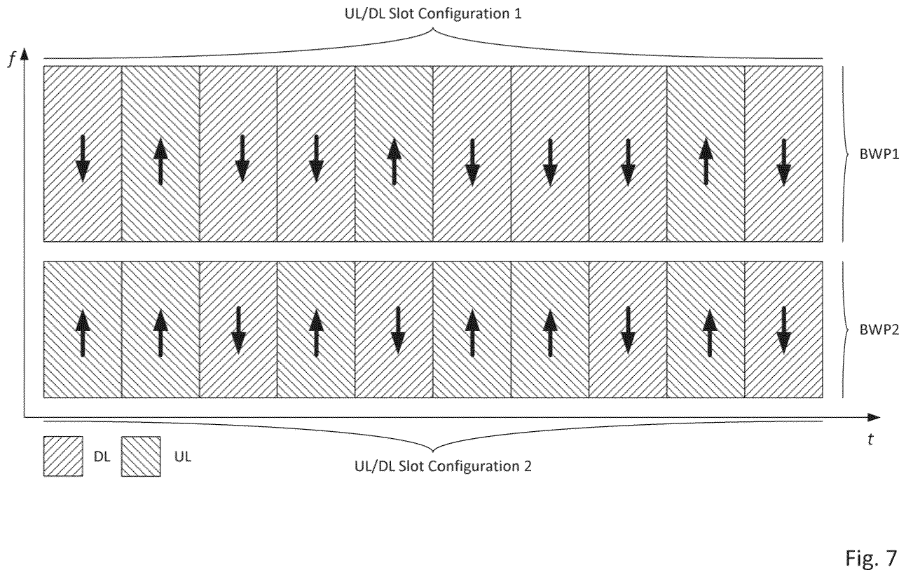

Referring to FIGS. 6 to 9, the UEs 3 and base station 5 of the communication system 1 are configured to provide support for at least one of two different possible subband non-overlapping FD schemes-inter-BWP full duplex and intra-BWP full duplex.

It will be appreciated that the inter-BWP full duplex and intra-BWP full duplex FD schemes described are not mutually exclusive and that they both be used by the same base station 5 and/or UE 3 depending on circumstances.

### Inter-BWP Full Duplex

Referring specifically to FIGS. 6 and 7, inter-BWP full duplex involves parallel UL and DL transmission in different BWPs.

As seen in FIG. 6, which is a simplified sequence diagram illustrating a full duplex configuration method in the communication system 1, the base station 5 configures the UEs 3 that it serves with an initial BWP (at S610). This initial BWP may be configured with a cell specific slot configuration (e.g. by means of system information) and/or a dedicated slot configuration (e.g., by means of RRC signalling) as generally described above.

The base station 5 also configures (at S612-1 and S612-2) each UE 3 with up to four BWPs, at least one of which has an associated BWP specific slot configuration (e.g., by means of RRC signalling).

As seen in FIG. 7, which is a simplified time frequency diagram showing an illustrative example of full duplex configuration according to the method of FIG. 6, the different BWP specific slot configurations allow a slot of one BWP to be configured as an uplink slot while the corresponding slot (i.e., having the same timing) in another BWP is configured as a downlink slot (or vice versa). Thus, UL from one UE 3 in one BWP may occur in parallel with DL communication to another UE 3 in another BWP. It will be appreciated that while not specifically illustrated the parallel UL/DL communication may be configured at a symbol level as well as at the slot level. Moreover, it will be appreciated that one or more flexible slots/symbols may be configured in one BWP while the same slots/symbols are configured as UL or DL slots/symbols in another BWP.

Different BWPs may thus be activated at different UEs (as seen as S614-1 and S614-2 in FIG. 6). Subband non-overlapping FD communication can thus take place at the base station 5 while half-duplex communication takes place at the UEs 3 (at S616). It will be appreciated that while the base station 5 is shown as activating the different BWPs at the UEs 3 by means of appropriate signalling (e.g., a scheduling DCI or the like) the respective BWP at each UE 3 may be activated (switched to) via any appropriate mechanism (e.g. on expiry of a BWP inactivity timer or initiation of a random-access procedure).

Beneficially, the communication system 1 implements one or more possible interference alleviation/avoidance mechanisms (as described in more detail later) to ameliorate interference issues that may otherwise arise as a result of implementing an inter-BWP FD scheme as described.

Beneficially, for this FD scheme, since each UE will be associated with a single BWP at a time, the impact on the UE 3 is minimal. Moreover, this inter-BWP full duplex advantageously provides for relatively simple isolation of interference between adjacent BWPs by using guard resources, if required, for example by using one or more of the possible interference alleviation/avoidance mechanisms described in more detail later.

This FD scheme does, however, require frequency partition (due to different BWPs) to enable full utilisation of full duplex and, in order to fully utilize the full duplexing functionality, the base station 5 may need to frequently switch BWPs of UEs. For example, if a first UE 3 is in BWP1 and DL transmission is currently taking place in BWP1 for a second UE 3, and UL transmission needs to be performed quickly by the first UE, then the base station 5 may need to schedule UL transmission in another BWP which will entail the first UE 3 switching to that BWP. Moreover, extension to subband overlapping full duplex in the future (if required) would require a different solution as BWPs are inherently non-overlapping.

The potential interference scenarios that are taken into account by the possible interference alleviation/avoidance mechanisms described in more detail later include, for example: the possibility that UEs undergoing DL transmission may experience interference from UL scheduled UEs in the same slot of an adjacent (in frequency) BWP; and the possibility that a base station's UL reception may be corrupted as a result of DL transmissions from the same base station in an adjacent (in frequency) BWP.

Among the possible interference alleviation/avoidance mechanisms described in more detail later, those that are particularly applicable to the inter-BWP (subband non-overlapping) FD comprise mechanisms for implementing a frequency gap (or ‘guard band’) between adjacent BWPs at least for slots (configured as FD slots) configured for UL communication in one of the adjacent BWPs and DL communication in another of the adjacent BWPs.

### Intra-BWP Full Duplex

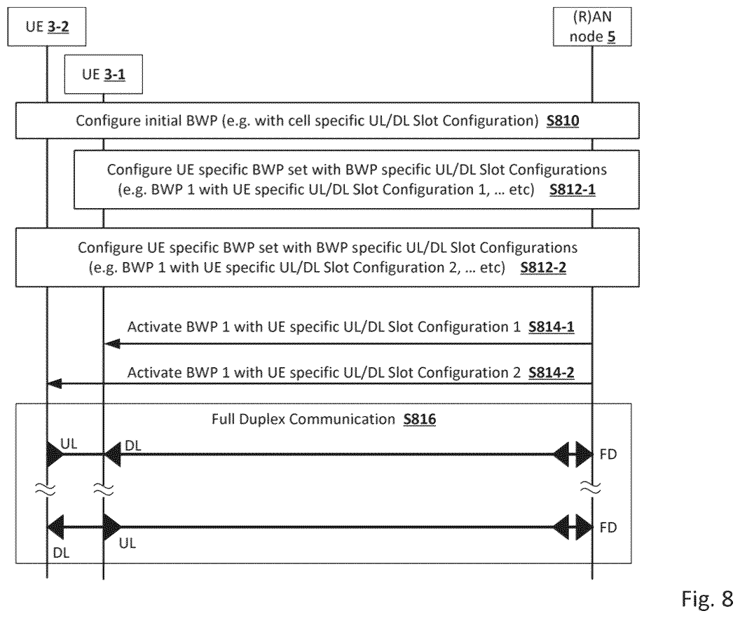

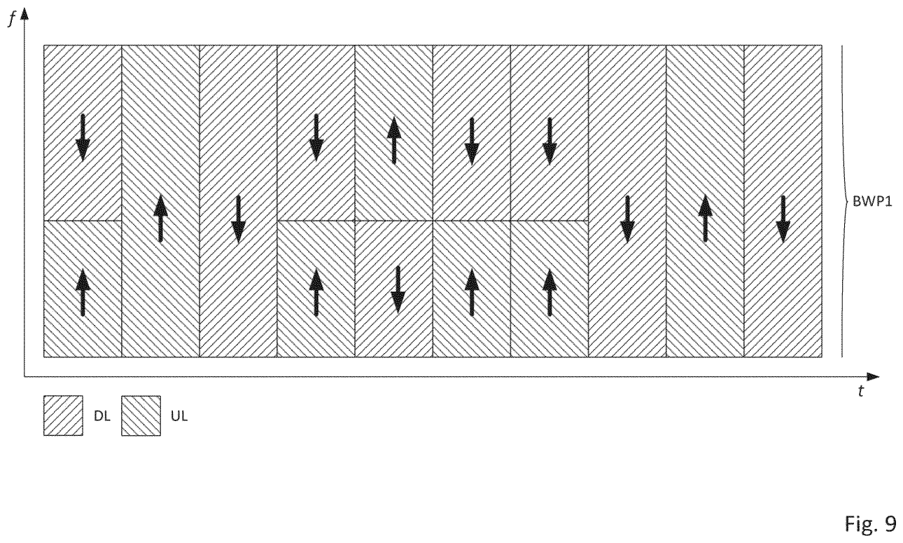

Referring specifically to FIGS. 8 and 9, inter-BWP full duplex involves parallel UL and DL transmission in different BWPs.

As seen in FIG. 8, which is a simplified sequence diagram illustrating a full duplex configuration method in the communication system 1, the base station 5 configures the UEs 3 that it serves with an initial BWP (at S810). This initial BWP may be configured with a cell specific slot configuration (e.g. by means of system information) and/or a dedicated slot configuration (e.g., by means of RRC signalling) as generally described above.

The base station 5 also configures (at S812-1 and S812-2) each UE 3 with up to four BWPs, at least one of which has an associated UE specific slot configuration (e.g., by means of RRC signalling). In this way UEs using the same BWP may have different UL/DL slot configurations.

For example, as seen in FIG. 9, which is a simplified time frequency diagram showing an illustrative example of full duplex configuration according to the method of FIG. 8, the different UE specific slot configurations allow a slot of a particular BWP to effectively be configured as an FD slot by configuring that slot for one UE as an uplink slot, while the same slot in the same BWP is configured as a downlink slot for another UE (or vice versa). Thus, UL communication from one UE 3 in that BWP may occur in parallel with DL communication to another UE 3 in the same BWP. It will be appreciated that while not specifically illustrated the parallel UL/DL communication may be configured at a symbol level as well as at the slot level.

It will also be appreciated that, as illustrated in FIG. 9 the base station 5 is configured to schedule frequency resources of any slot configured as an FD slot in a particular BWP, to ensure that the frequency resources scheduled for UL communication by one UE are part of a different subband of that BWP, than the frequency resources scheduled for DL communication to another UE.

The same BWP may thus be activated at different UEs (as seen as S814-1 and S814-2 in FIG. 8). Subband non-overlapping FD communication can thus take place at the base station 5 while half-duplex communication takes place at the UEs 3 (at S816). It will be appreciated that while the base station 5 is shown as activating the different BWPs at the UEs 3 by means of appropriate signalling (e.g., a scheduling DCI or the like) the respective BWP at each UE 3 may be activated (switched to) via any appropriate mechanism (e.g. on expiry of a BWP inactivity timer or initiation of a random-access procedure).

Beneficially, this FD scheme provides more flexibility for the base station 5, than inter-BWP FD, to control FD communication.

Beneficially, the communication system 1 implements one or more possible interference alleviation/avoidance mechanisms (as described in more detail later) to ameliorate interference issues that may otherwise arise as a result of implementing an intra-BWP FD scheme.

The potential interference scenarios that are taken into account by the interference alleviation/avoidance mechanisms described in more detail later include, for example, the possibility that UEs undergoing DL transmission may experience interference from UL scheduled UEs in the same slot. This can become a significant issue if this interferes with DL reference signals. While this can be somewhat addressed by the base station 5 making sure that UL scheduled UEs are distant from DL scheduled UEs (e.g. using different beams), and interference to DL UEs can be further reduced by appropriate use of DCI format 2_4 (UL preemption), additional interference alleviation/avoidance would be beneficial.

The potential interference scenarios that are taken into account by the possible interference alleviation/avoidance mechanisms described in more detail later also include, for example, the possibility that some UEs may try to receive DL channels (e.g. semi static signals such as CSI-RS) which may not be present due to UL transmission in a subset of cell bandwidth-which could result in incorrect channel estimation. Beneficially, for example, some of the possible interference alleviation/avoidance mechanisms are directed at ensuring that DL UEs do not try to receive DL channels where UL scheduling is ongoing and some at avoiding scheduling of DL resources where PUCCH resources are present.

The potential interference scenarios that are taken into account by the possible interference alleviation/avoidance mechanisms described in more detail later also include, for example, the possibility that a base station's UL reception may be corrupted as a result of DL transmissions from the same base station.

### Interference Alleviation/Avoidance

A number of possible interference alleviation/avoidance mechanisms will now be described in more detail, by way of example only. These mechanisms have been grouped, in the interests of clarity, into the following broad categories:
Implementing gap between UL and DL BWPs
Adjusting transmission bandwidth/resources for semi-static signals/channels
Selective pre-emption of dynamic UL/DL signalling
Enhanced DL decoding near the interference region
Pro-active UE compensation for DL degradation

It will be appreciated that the mechanisms described are not mutually exclusive and that one or more of the mechanisms may be used by the same base station 5 and/or UE 3 for the alleviation/avoidance of interference in between adjacent subbands configured for subband non-overlapping FD.

### Implementing Gap Between UL and DL BWPs

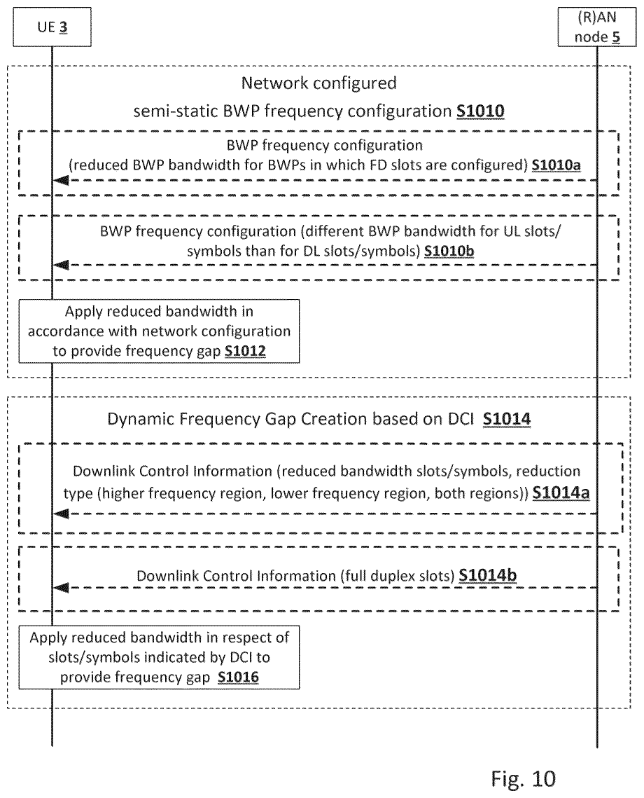

Referring to FIGS. 10 to 12 a number of mechanisms will now be described in which the UE updates the DL reception and/or UL transmission bandwidth for UL/DL transmissions, based on information provided from the network, to implement a frequency gap, for a slot configured for full duplex communication, between a UL slot in one BWP and a coinciding DL slot in another BWP.

As seen in FIG. 10, which is a simplified sequence diagram illustrating a number of different possible interference alleviation/avoidance mechanisms that can be employed in the communication system 1, the network can ensure a minimum frequency gap between the BWPs by providing a semi-static BWP frequency configuration as shown at S1010.

This can be achieved by the base station 5 providing (e.g., in system information or via an RRC message) a BWP frequency configuration that indicates a reduced BWP for a BWP in which one or more FD slots (or symbols) are configured (at S1010a). Whilst network configuration in this manner has the benefit of simplicity it has the potential to be wasteful of radio resources because the resources in the frequency gap are not available even in slots in which FD does not take place.

To alleviate the issues associated with the unavailability of radio resources in the frequency gap (albeit at the expense of slightly increased complexity), the base station 5 can provide (e.g., in system information or via an RRC message) a BWP frequency configuration that indicates a different BWP bandwidth for UL slots/symbols than for DL slots/symbols (as seen at S1010b). In effect therefore, this mechanism involves configuring a frequency gap for only DL slots/symbols or for only UL slots/symbols.

The UE 3 can then apply a reduced bandwidth in accordance with network configured BWP bandwidth(s) to provide an appropriate frequency gap and thus alleviate/avoid interference (at S1012).

As seen in FIG. 10, other possible interference alleviation/avoidance mechanisms that can be employed in the communication system 1, can involve dynamic frequency gap implementation (by BWP bandwidth reduction) based on downlink control information as shown at S1014.

In one dynamic, DCI based mechanism, the network indicates in the DCI that for a set of time occasions (slots/symbols) BWP bandwidth is reduced temporarily (as seen at S1014a). The DCI, in this example, indicates specific slots/symbols in which a reduced bandwidth is applicable. The DCI may also indicate to the recipient UE 3 whether the bandwidth is reduced within the higher frequency region (subband), within the lower frequency region (subband), or within both the higher frequency region and the lower frequency region. The UE 3 then applies, for the indicated slots/symbols, a frequency gap by updating the transmission/reception bandwidth with an appropriate bandwidth reduction at S1016.

In another dynamic, DCI based mechanism, the network indicates in the DCI which slots are full duplex type slots (as seen at S1014b) and the UE 3 applies, for all indicated FD slots, a frequency gap by updating the transmission/reception bandwidth with an appropriate bandwidth reduction at S1016.

In the indicated FD slots the UE 3 may implement the frequency gap in a number of different ways. The UE 3 may, for example, implement the frequency gap in the FD slots:
1. By applying the frequency gap, by default, in respect of frequency resources, near the boundary of adjacent UL/DL BWPs, of both (or either) the BWP in which the slot is configured for UL communication (the ‘UL BWP’) and/or in the BWP in which the slot is configured for DL communication (the ‘DL BWP’).
2. By applying the frequency gap in respect of frequency resources, near the boundary of adjacent UL/DL BWPs, of only the UL BWP for slots indicated by a common slot configuration, or a dedicated slot configuration, to be a DL slot.
3. By applying the frequency gap in respect of frequency resources, near the boundary of adjacent UL/DL BWPs, of only the DL BWP for slots indicated by a common slot configuration, or a dedicated slot configuration, to be a UL slot.
4. By applying the frequency gap in respect of frequency resources at both edges of both the UL BWP and the DL BWP.

While any of these frequency gap implementation methods may be used in isolation they may also be used in combination. For example, the combination of the frequency gap implementation methods to be used by the UE 3 may be provided dynamically by the base station 5 in DCI, or may be configured by the base station using appropriate RRC signalling. For example, the base station 5 may indicate use of frequency gap implementation method 1, 2, and 3 in one scenario and the use of frequency gap implementation method 4 in another.

Moreover, in respect of frequency gap implementation methods 2 and 3, these may be applied based on other factors. For example, frequency gap implementation method 2 and/or 3 may be implemented in a BWP specific manner in which the network configures the UE to enable frequency gap implementation method 2 and/or 3 for a specific BWP. As part of this configuration the network may also provide a frequency region to which the frequency gap needs to be applied. Similarly, frequency gap implementation method 2 and/or 3 may be applied, in a restricted manner, for only a BWP which is near a cell bandwidth boundary. In this case, the frequency gap would be applied in the frequency region near, or adjacent, the cell bandwidth boundary.

A specific frequency gap value to be applied may be either configured (e.g., by RRC signalling/system information) or dynamically provided in DCI.

It can be seen that this frequency gap can be applied by appropriate bandwidth reduction for example: by bandwidth reduction of the UL BWP when a slot is indicated to be a DL slot by a common slot configuration, or a dedicated slot configuration (frequency gap implementation method 2); by bandwidth reduction of the DL BWP when a slot is indicated to be a UL slot by a common slot configuration, or a dedicated slot configuration (frequency gap implementation method 3); otherwise by bandwidth reduction of the UL BWP and/or the DL BWP (frequency gap implementation methods 1 or 4) based on network configuration or DCI signalling.

It will be appreciated that any suitable DCI format may be used for indicating the set of time occasions (slots/symbols) for which the BWP bandwidth is reduced temporarily and/or for identifying the full duplex slots. For example, an existing DCI format may be adapted (e.g., a slot configuration DCI, UL/DL grant DCI, or any other DCI) or a new DCI format may be used.

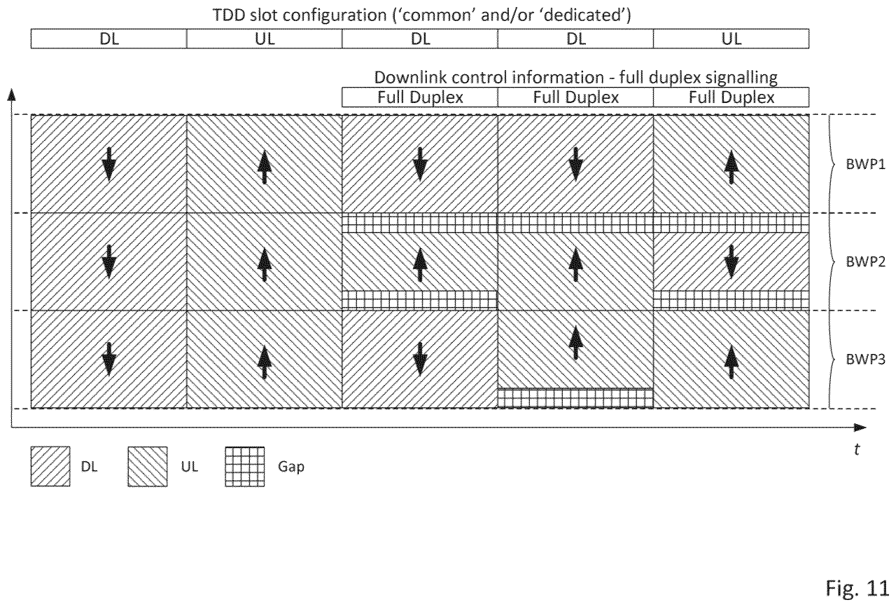

Referring to FIG. 11, which is a simplified time frequency diagram showing an illustrative example of a possible frequency gap implementation, this illustrates how the gap may be implemented in a number of slots indicated by DCI to be FD slots for a configuration involving three bandwidth parts, in which BWP1 is configured by a common and/or dedicated slot configuration to have a specific TDD UL/DL slot arrangement. As seen in FIG. 11, in the illustrated example, the frequency gaps are introduced in the BWPs for which a slot is configured for communication in the opposite direction to that indicated by the common and/or dedicated slot configuration.

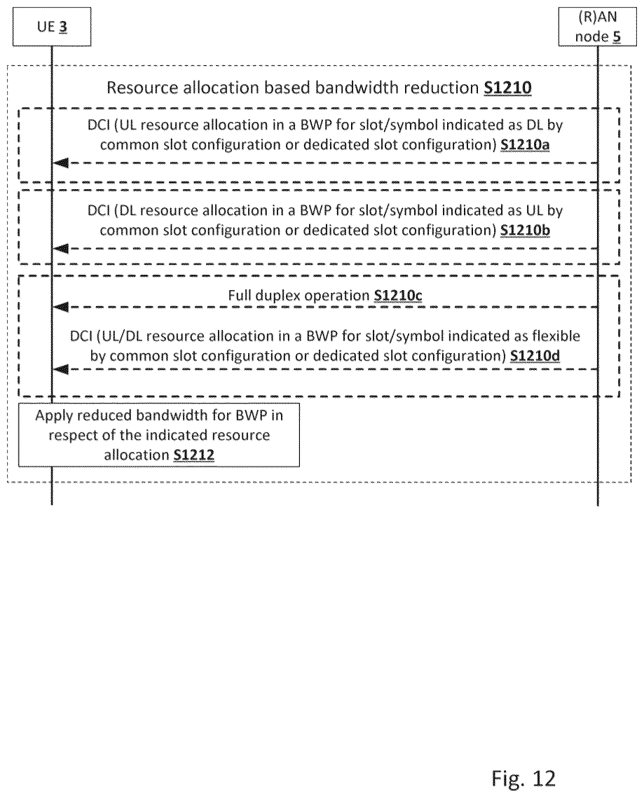

Turning now to FIG. 12, which is a simplified sequence diagram illustrating a number of other possible interference alleviation/avoidance mechanisms that can be employed in the communication system 1, bandwidth reduction for the purpose of implementing a frequency gap may also be based on a resource allocation provided by the base station 5 as seen generally at S1210.

In one resource allocation based mechanism, for example, if a UE receives a UL resource allocation in a BWP, via DCI, in a slot/symbol indicated by a common slot configuration or a dedicated slot configuration to be a DL slot/symbol (as seen at S1210a) then the UE 3 applies a reduced bandwidth for that BWP, for the indicated resource allocation (at S1212). Similarly, if a UE receives a DL resource allocation in a BWP, via DCI, in a slot/symbol indicated by a common slot configuration or a dedicated slot configuration to be a UL slot/symbol (as seen at S1210a) then the UE 3 applies a reduced bandwidth for that BWP, for the indicated resource allocation (at S1212). In this scenario, the reduced bandwidth value (or the size of the frequency gap to be implemented) can be indicated to UE 3 via DCI or using RRC configuration signalling.

In another resource allocation based mechanism, for example, the base station 5 may configure the UE with a full duplex operation parameter (as seen at S1210c). The full duplex operation parameter may be provided in any suitable way, for example, the parameter may be dedicatedly configured to the UE 3 by the base station 5 (e.g. using a dedicated RRC configuration or the like). It will be appreciated that, for some UEs 3, the base station 5 may not configure this parameter, while for other UEs 3, the base station may configure this parameter. Accordingly, the network may selectively configure UEs 3 for full duplex operation. If the UE 3 then receives an UL or DL resource allocation within a flexible slot, then the UE 3 applies a reduced bandwidth for the BWP/cell for the indicated resource allocation.

If a UE receives a UL resource allocation in a BWP, via DCI, in a slot/symbol indicated by a common slot configuration or a dedicated slot configuration to be a DL slot/symbol (as seen at S1210a) then the UE 3 applies a reduced bandwidth for that BWP, for the indicated resource allocation (at S1212). Similarly, if a UE receives a DL resource allocation in a BWP, via DCI, in a slot/symbol indicated by a common slot configuration or a dedicated slot configuration to be a UL slot/symbol (as seen at S1210a) then the UE 3 applies a reduced bandwidth for that BWP, for the indicated resource allocation (at S1212). In this scenario, the reduced bandwidth value (or the size of the frequency gap to be implemented) can be indicated to UE 3 via DCI or using RRC configuration signalling.

It will be appreciated that the frequency gap created based on any of these mechanisms can be different for UEs that do not support full duplex and UEs which do support full duplex operation.

It will be appreciated that even though the mechanisms have been described in the context of interference mitigation between UL and DL communications in a single cell, the mechanisms can also be adapted to alleviate inter-cell interference (e.g. near a boundary between neighbouring/overlapping cells when a BWP for one cell is configured for UL communication and a BWP for the neighbouring/overlapping cell is configured for DL communication).

### Adjusting Transmission Bandwidth/Resources for Semi-Static Signals/Channels

For dynamic transmissions (e.g. PDSCH/PUSCH) a frequency gap can be created between subbands configured for uplink transmission and subbands configured for downlink transmission in a relatively straightforward manner based on network implementation.

However, the situation for semi-static resource allocations (e.g., semi-static allocations for CSI-RS/SRS/PUCCH etc.) the situation is not straightforward.

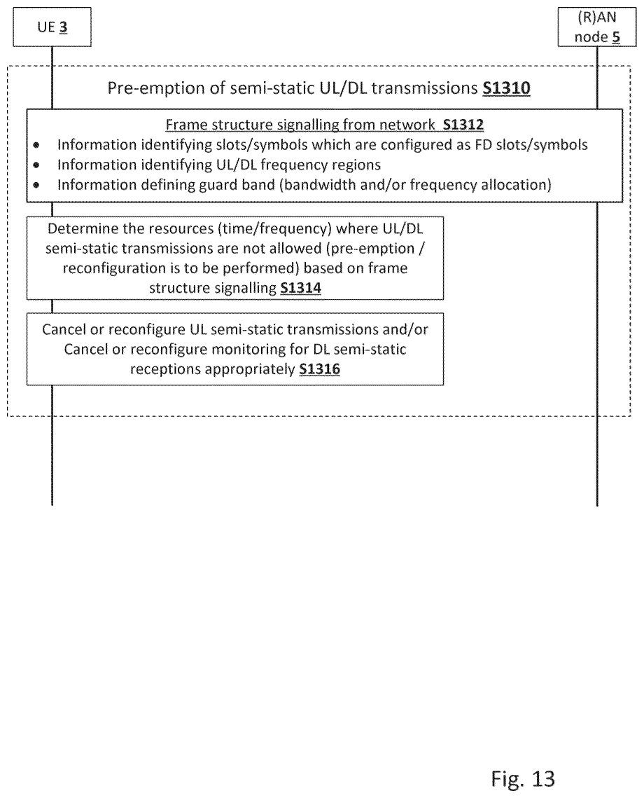

A number of possible interference alleviation/avoidance mechanisms that are generally applicable to semi-static signals/channels will now be described, by way of example only, with reference to FIGS. 13 to 15.

FIG. 13 is a simplified sequence diagram illustrating a possible interference alleviation/avoidance mechanism for semi-static signals/channels that can be employed in the communication system 1 to allow appropriate pre-emption, rate matching and puncturing of physical semi-static transmissions.

The interference alleviation/avoidance mechanism of FIG. 13 involves pre-emption of physical UL/DL transmissions (as indicated as S1310) using frame structure signalling from the base station 5 (as indicated as S1312). The frame structure signalling beneficially indicates the structure of the frame to the UE 3 in a manner that allows the UE 3 to determine where UL transmissions (e.g. of SRS, PUCCH or the like) need to be cancelled (or reconfigured to use different resources) to avoid possible conflict with DL transmissions. The frame structure signalling also indicates the structure of the frame to the UE 3 in a manner that allows the UE 3 to determine where DL receptions (e.g. of CSI-RS) will be cancelled (or reconfigured to use different resources) to avoid possible conflict with UL transmissions, and thereby allows the UE 3 to avoid incorrectly attempting to receive DL transmissions (e.g. of CSI-RS) that do not exist. It will be appreciated that the frame structure signalling need not provide all the frame information in a single message, or using a single type of signalling (e.g., DCI, RRC, system information or the like).

As seen in FIG. 13 the frame structure signalling from the base station 5 includes information identifying slots/symbols which are configured as full duplex type slots/symbols. This information may, for example, be in the form of information indicating for the FD type slots/symbols that those slots/symbols are configured for both UL and DL. The information may be in the form of information indicating that an FD slot/symbol: is an UL slot/symbol, when that slot/symbol is configured as a DL slot/symbol by the common slot configuration or dedicated slot configuration; and is a DL slot/symbol, when that slot/symbol is configured as a UL slot/symbol by the common slot configuration or dedicated slot configuration.

The frame structure signalling from the base station 5 also includes information identifying the UL and DL frequency regions (subbands) to be used for FD communication (this may be indicated dynamically using DCI or may be configured by RRC signalling).

The frame structure signalling from the base station 5 also includes information defining a guard band where no UL or DL transmissions are to be performed. The guard band may be explicitly defined by DCI (e.g., identifying a specific frequency allocation) or may be implicitly defined (e.g., by the network configuring a bandwidth for the guard band and UE 3 assuming that the guard band is always present between the defined UL and DL frequency ranges).

The frame structure signalling may also include information identifying one or more beams, of a set of beams configured for communication with the base station 5, that UL transmission and/or DL transmission is not allowed for (and/or is allowed for).

Based on the frame structure signalling (possibly in conjunction with the TDD common/dedicated slot configuration), the UE 3 is able to determine (at S1314) the time occasions and frequency resources where UL/DL semi-static transmissions are/are not allowed (and hence pre-emption/resource reconfiguration is to be performed).

The UE 3 can thus cancel, or reconfigure the resources for, UL transmissions and/or can cancel, or reconfigure resources for, monitoring for DL receptions (at S1316).

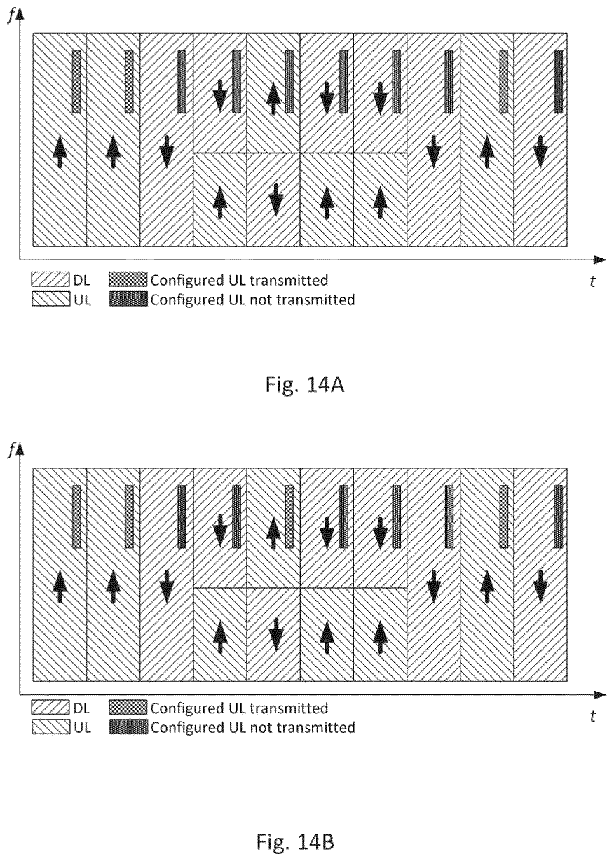

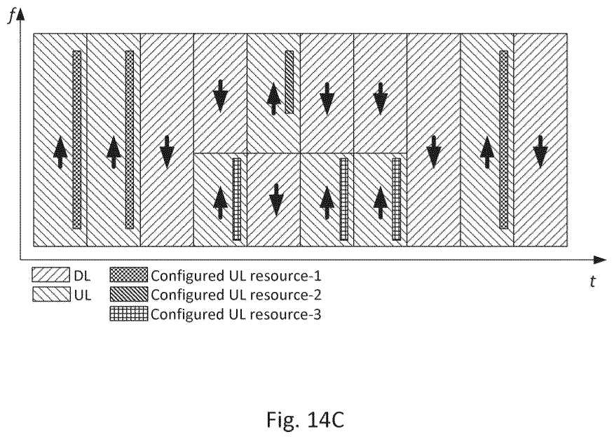

There are a number of different ways in which the UE 3 may cancel, or reconfigure the resources for, UL transmissions and/or may cancel, or reconfigure resources for, monitoring for DL receptions. Some of these will now be described with reference to FIGS. 14A to 14C which are time frequency diagrams each showing a respective illustrative example of how pre-emption/reconfiguration may take place for an UL transmission.

The UE 3 may cancel, or reconfigure the resources for, UL transmissions and/or may cancel, or reconfigure resources for, monitoring for DL receptions according to any of the following:
1. The UE 3 determines that, in the indicated full duplex slots, any configured UL transmission (e.g., configured grant (CG), PUCCH, and/or SRS transmissions) and/or monitoring for any DL reception (e.g., CSI-RS) should be cancelled (this is illustrated for a configured UL transmission in FIG. 14A).
2. The UE 3 determines that configured UL transmission is allowed only if the UL resource bandwidth is within the bandwidth available for the UL in the full duplex slots and/or that DL reception is required only if the DL resource bandwidth is within the bandwidth available for the DL in the full duplex slots (this is illustrated for a configured UL transmission in FIG. 14B).
3. The UE 3 determines that configured UL transmissions are allowed only if the UE 3 is connected via a beam for which UL transmission is indicated to be allowed by the frame structure signalling and/or that DL receptions are needed only if the UE 3 is connected via a beam for which DL transmission is indicated to be allowed by the frame structure signalling.
4. The UE 3 determines that configured UL transmissions are allowed only for high priority UL transmissions and/or that DL receptions are needed only for high priority DL receptions.
5. In this example, UL resource configurations are provided to the UE 3 for full duplex slots/symbols and the UE determines to perform uplink transmission using a UL resource configuration having a bandwidth that is located entirely within the UL bandwidth of the full duplex slot/symbol. Similarly, DL resource configurations may be provided to the UE 3 for full duplex slots/symbols and the UE may determine to monitor for downlink reception using a DL resource configuration having a bandwidth that is located entirely within the DL bandwidth of the full duplex slot/symbol.

It will be appreciated that different approaches described above may be followed for different channels. For example, approach 4 may be used for configured UL grant, approach 1 may be used for SRS, and approach 2 may be used for PUCCH. Another variation might be that for PUCCH transmissions, either approach 5 or approach 2, may be applicable but only for scheduling request transmission.

For these different approaches, for UL transmission cancellation, the UL cancellation may be performed only if the slot/symbol for the configured UL transmission is not configured as an UL slot by the common slot configuration or the dedicated slot configuration.

For these different approaches, for DL reception cancellation, the DL cancellation may be performed only if the slot/symbol for the configured DL reception is not configured as an DL slot by the common slot configuration or the dedicated slot configuration.

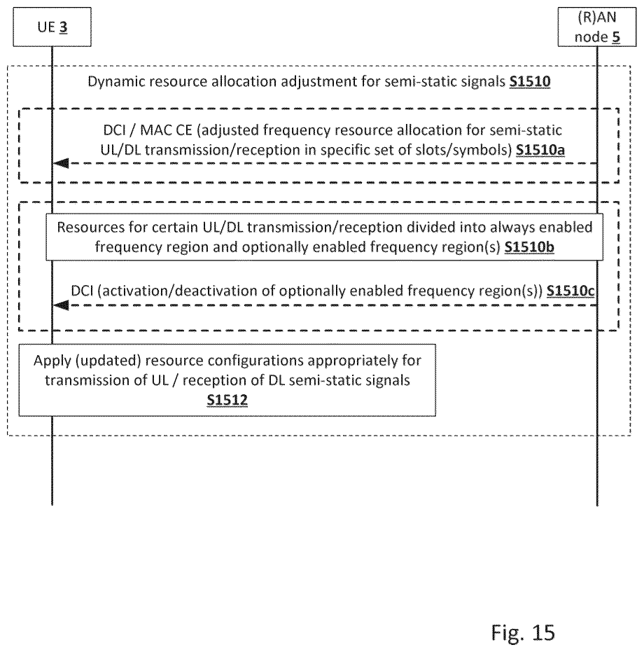

FIG. 15 is a simplified sequence diagram illustrating other possible interference alleviation/avoidance mechanisms for semi-static signals/channels that can be employed in the communication system 1.

The interference alleviation/avoidance mechanisms of FIG. 15 involve some form of dynamic adjustment of the resource allocation for semi-static signals via DCI signalling or a Medium Access Control (MAC) Control Element (as indicated as S1510).

In one mechanism, the base station 5 dynamically updates the resource configuration for UL/DL semi-static signals by indicating using DCI, or a MAC CE, adjusted frequency resource allocation for a given set of time occasions (as indicated as S1510a).

In another mechanism, some of the resources configured for UL and/or DL semi-static signals are divided into a plurality of (possibly two) frequency regions where at least one of those frequency regions is always enabled, and at least one other may be activated or deactivated depending on need (i.e., is ‘optionally enabled’) as seen at S1510b. The base station 5 can then dynamically update the resource configuration for UL/DL semi-static signals by activating/deactivating the optionally enabled frequency region(s) based on DCI (at S1510c).

Accordingly, the UE 3 can apply the updated resource configurations appropriately for transmission of UL/reception of DL semi-static signals (at S1512).

It will be appreciated that any of these mechanisms may be applied for each of the UL/DL physical signals/channels.

### Selective Pre-Emption of Dynamic UL/DL Signalling

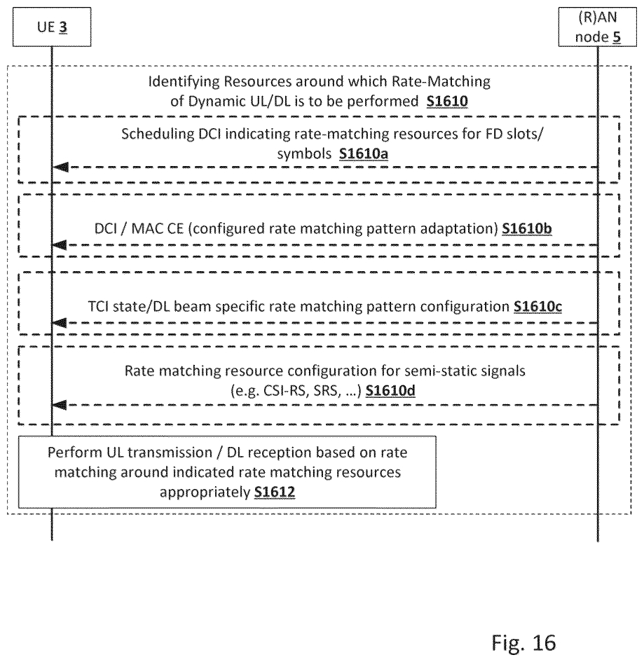

A number of possible interference alleviation/avoidance mechanisms that are generally applicable to dynamic UL/DL transmissions (e.g. in the PUSCH/PDSCH) will now be described, by way of example only, with reference to FIGS. 16 to 18.

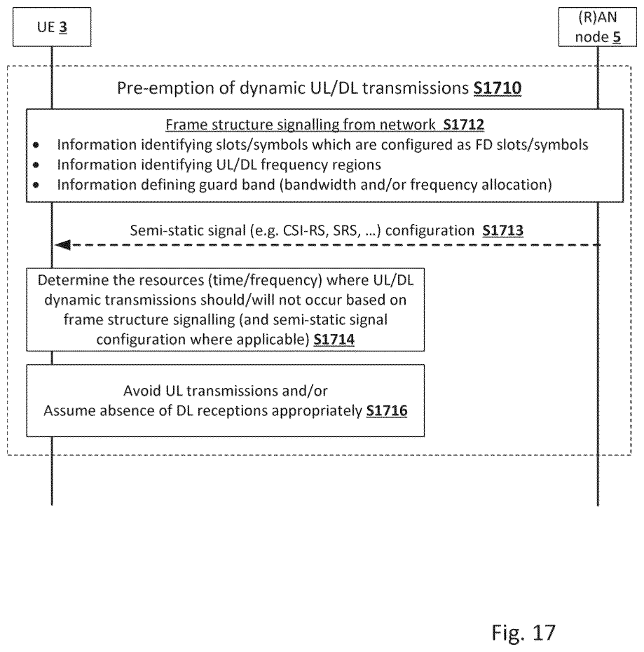

FIGS. 16 and 17 are each a simplified sequence diagram illustrating a number of possible interference alleviation/avoidance mechanisms related to pre-emption of dynamic UL/DL signalling in the communication system 1.

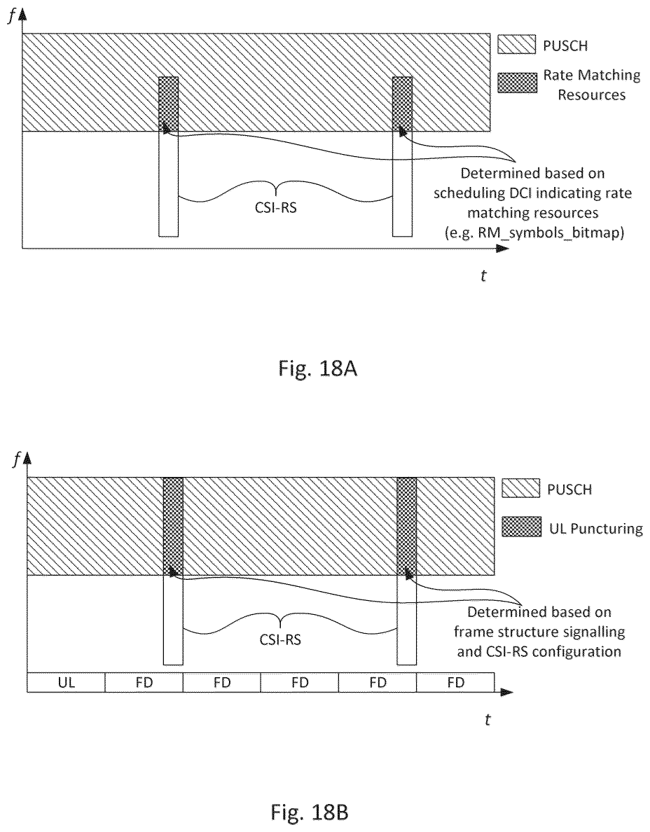

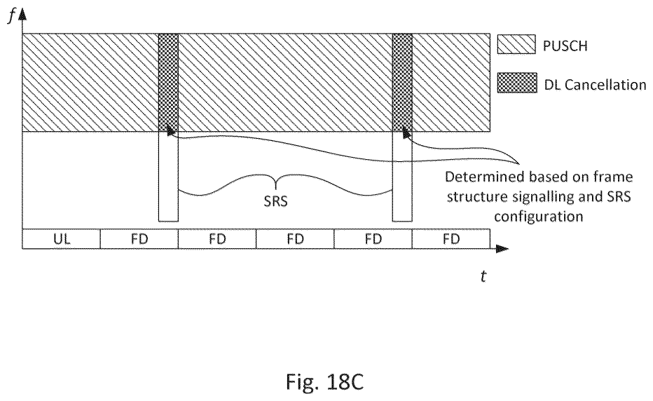

FIGS. 18A to 18C are time frequency diagrams each showing a respective illustrative example of how resources may be identified for pre-empted dynamic transmissions in the communication system 1.

Some UL/DL transmissions (e.g. PUSCH/PDSCH) can be allocated for multiple symbols/slots while interference on DL is only severe for a subset of the allocated symbols, hence cancelling UL/DL transmission in the interfering frequency resources for the entire allocated duration can be inefficient.

Accordingly, improved pre-emption is desirable to allow UL/DL transmissions to be cancelled during the specific time occasions which can cause the most interference. This is particularly beneficial for multi-slot PUSCH/PDSCH transmissions.

Nevertheless, improved pre-emption is complex because the time occasions where interference occurs depends on base station scheduling decisions and hence can be very dynamic.

In order to provide for improved pre-emption of the specific resources to which interference is most likely to be significant additional (FD specific) rate matching patterns can be configured (e.g., by means of RRC signalling). The base station can then notify the UE 3 of the rate matching resources around which rate-matching of dynamic UL/DL signalling is to be performed.

FIG. 16 is a simplified sequence diagram illustrating a number of possible interference alleviation/avoidance mechanisms for identifying (FD specific) rate matching resources that can be employed in the communication system 1.

The interference alleviation/avoidance mechanisms of FIG. 16 all involve some form of identification of resources around which rate-matching of the dynamic UL/DL is to be performed (as indicated as S1610).

As seen at S1610a, a scheduling DCI may be used to indicate the rate-matching resources (both time and frequency resources). This may, for example, by means of indicating, within the scheduling DCI, specific time occasions where a configured rate matching pattern shall apply (frequency resources can be preconfigured). The indication of the rate matching resources may be provided by means of a rate matching pattern index that points to a particular configured (FD specific) rate matching pattern. Whilst a scheduling DCI format exists that includes a rate matching indicator (DCI format 1_1) the size of the indicator is limited to 2 bits and so if this indicator is to be used for indicating a particular configured (FD specific) rate matching pattern then an increase in the maximum number of bits used for the indicator may be appropriate.

As seen at S1610b, a DCI or MAC CE (e.g. a dedicated DCI/MAC CE) may be used to dynamically update a previously configured (e.g. by RRC signalling) rate matching pattern.

As seen at S1610c, the network may configure (e.g. using RRC signalling) the UE with a number of transmission configuration indicator (TCI) state and/or DL beam specific rate matching patterns. Accordingly, the UE 3 can determine a rate matching pattern based on the TCI state and/or DL beam via which the UE 3 is connected and apply appropriate rate matching accordingly.

As seen at S1610d, the network may indicate to the UE 3 (e.g. using RRC signalling) a semi-static signal (e.g. CSI-RS or SRS) rate matching resource configuration where UL/DL rate matching is to be performed. The resource configurations for the semi-static (CSI-RS or SRS) resources can be configured by base station 5 to UE 3 appropriately (e.g., using RRC signalling). Specifically, a base station 5 CSI-RS resource can be configured as rate matching resource for UL and SRS resource can be configured as rate matching resource for DL (because this is currently not supported in 3GPP specification).

Accordingly, regardless of which rate matching resource indication mechanism (or combination of mechanisms) is used the UE 3 is able to perform UL transmission/DL reception based on rate matching around indicated rate matching resources appropriately (at S1612).

FIG. 18A is an illustrative example of how such rate matching information may be used for identifying appropriate rate matching resources for pre-empted PUSCH transmissions.

FIG. 17 is a simplified sequence diagram illustrating a number of possible interference alleviation/avoidance mechanisms for dynamic UL/DL channels that can be employed in the communication system 1.

FIG. 17, and the mechanisms it illustrates, are similar to those shown in, and described with reference to, FIG. 13 for pre-emption of semi-static signals.

Like the that of FIG. 13, the interference alleviation/avoidance mechanism of FIG. 17 involves pre-emption based on frame structure signalling from the network. However, the mechanism illustrated in FIG. 17 relates to pre-emption of dynamic (rather than semi-static) UL/DL transmissions (as indicated as S1710) using the frame structure signalling from the base station 5 (provided at S1712). The frame structure signalling beneficially indicates the structure of the frame to the UE 3 in a manner that allows the UE 3 to determine where UL transmissions (e.g. of PUSCH or the like) need to be avoided to avoid possible conflict with DL transmissions (e.g., of CSI-RS). The frame structure signalling also indicates the structure of the frame to the UE 3 in a manner that allows the UE 3 to determine where DL receptions (e.g. of PDSCH) will not be present to avoid possible conflict with UL transmissions (e.g., of SRS). It will be appreciated that the frame structure signalling need not provide all the frame information in a single message, or using a single type of signalling (e.g., DCI, RRC, system information or the like).

As seen in FIG. 17 the frame structure signalling from the base station 5 includes information identifying slots/symbols which are configured as full duplex type slots/symbols. This information may, for example, be in the form of information indicating for the FD type slots/symbols that those slots/symbols are configured for both UL and DL. The information may be in the form of information indicating that an FD slot/symbol: is an UL slot/symbol, when that slot/symbol is configured as a DL slot/symbol by the common slot configuration or dedicated slot configuration; and is a DL slot/symbol, when that slot/symbol is configured as a UL slot/symbol by the common slot configuration or dedicated slot configuration.

The frame structure signalling from the base station 5 also includes information identifying the UL and DL frequency regions (subbands) to be used for FD communication (this may be indicated dynamically using DCI or may be configured by RRC signalling).

The frame structure signalling from the base station 5 also includes information defining a guard band where no UL or DL transmissions are to be performed. The guard band may be explicitly defined by DCI (e.g., identifying a specific frequency allocation) or may be implicitly defined (e.g., by the network configuring a bandwidth for the guard band and UE 3 assuming that the guard band is always present between the defined UL and DL frequency ranges).

The frame structure signalling may also include information identifying one or more beams, of a set of beams configured for communication with the base station 5, that UL transmission and/or DL transmission is not allowed for (and/or is allowed for).

The base station 5, in this example, may also provide (at S1713) information identifying configuration(s) for semi-static signalling (e.g., for the CSI-RS and/or SRS).

Based on the frame structure signalling (possibly in conjunction with the TDD common/dedicated slot configuration and/or semi-static signal resource configuration), the UE 3 is able to determine (at S1714) the time occasions and frequency resources where UL/DL dynamic transmissions are/are not allowed.

The UE 3 can thus avoid UL transmissions and/or can assume an absence of DL receptions accordingly (at S1716).

In relation to UL transmissions (e.g., PUSCH) UE 3 may avoid UL transmissions according to any of the following:
1. The UE 3 determines that UL transmission is not to be performed on the subset of UL resources which occur during symbols/slots indicated to be full duplex unless the slot/symbol for the configured UL transmission is indicated to be a UL slot/symbol by the common slot configuration and/or dedicated slot configuration.
2. The UE 3 determines that UL transmission is to be punctured for the UL resources which are outside the indicated UL frequency region indicated by the frame structure signalling, of the full duplex slots.
3. In the case that a CSI-RS configuration is provided (at S1713) by the base station, the UE 3 determines where UL transmissions are to be avoided based on both the CSI-RS configuration and the frame structure signalling (as shown in the illustrative example shown in FIG. 18B. In accordance with this, for example:
   The UE 3 may determine that UL transmissions, which would otherwise occur during CSI-RS occasions indicated by the base station 5 in the CSI-RS configuration, and which occur within full duplex slots/symbols, should not be performed;
   The UE 3 may determine that UL transmissions, which would otherwise occur during zero power (ZP) CSI-RS occasions indicated by the base station 5 in the CSI-RS configuration, and which occur within full duplex slots/symbols, should not be performed;
   The CSI-RS configuration may indicate to UE for which CSI-RS occasions transmissions should not be performed during full duplex slots/symbols. The UE 3 may then determine not to perform UL transmissions which would otherwise occur during the indicated CSI-RS occasions within full duplex slots/symbols;
   In addition to above, the UE 3 may cancel UL transmissions only for the CSI-RS resources whose beam/TCI state is same, or near to the UE's beam/TCI state.

In relation to DL receptions (e.g., PDSCH) UE 3 may assume that DL transmissions are not performed according to any of the following:
1. The UE 3 assumes that DL transmission will not be performed on the subset of DL resources which occur during symbols/slots indicated to be full duplex unless the slot/symbol for the configured DL transmission is indicated to be a DL slot/symbol by the common slot configuration and/or dedicated slot configuration.
2. The UE 3 assumes that DL transmission will be punctured for the DL resources which are outside the indicated DL frequency region indicated by the frame structure signalling, of the full duplex slots.
3. In the case that an SRS configuration is provided (at S1713) by the base station, the UE 3 determines where DL transmissions will not be performed based on both the SRS configuration and the frame structure signalling (as shown in the illustrative example shown in FIG. 18C. In accordance with this, for example:
   The UE 3 may not receive DL transmissions, which would otherwise occur during SRS occasions indicated by the base station 5 in the SRS configuration, and which occur within full duplex slots/symbols;
   The UE 3 may not receive DL transmissions, which would otherwise occur during zero power (ZP) SRS occasions indicated by the base station 5 in the SRS configuration, and which occur within full duplex slots/symbols;
   The SRS configuration may indicate to UE for which SRS occasions transmissions will not be performed during full duplex slots/symbols. The UE 3 may then not receive DL transmissions which would otherwise occur during the indicated SRS occasions within full duplex slots/symbols;
   In addition to above, the UE 3 may cancel DL receptions only for the SRS resources whose beam/TCI state is same, or near to the UE's beam/TCI state.

### Enhanced DL Decoding Near the Interference Region

In order to alleviate the impact of interference, DL decoding can also be enhanced-especially in respect of the frequency region, closest to the UL subband configured for FD communication, where significant interference is most likely to be experienced.

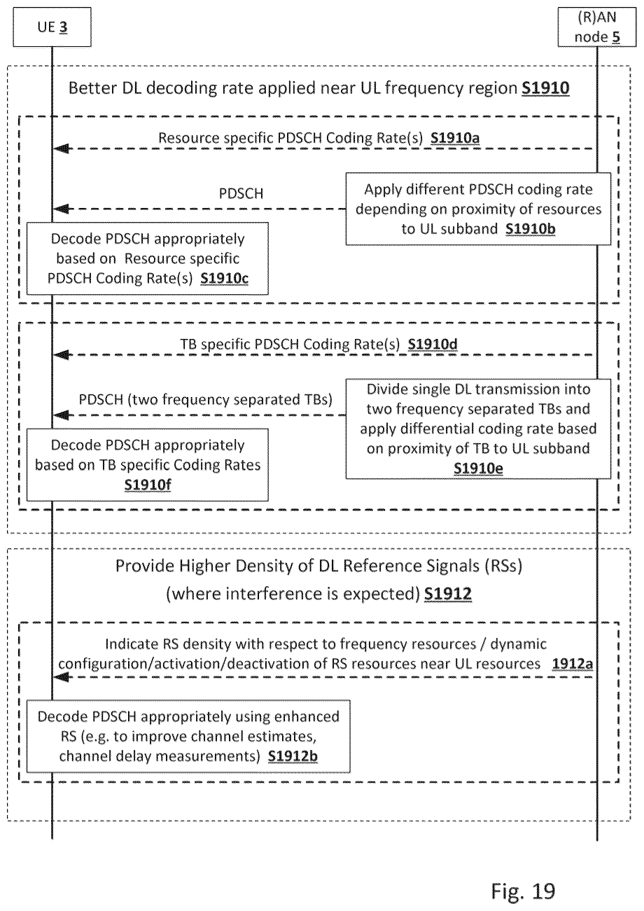

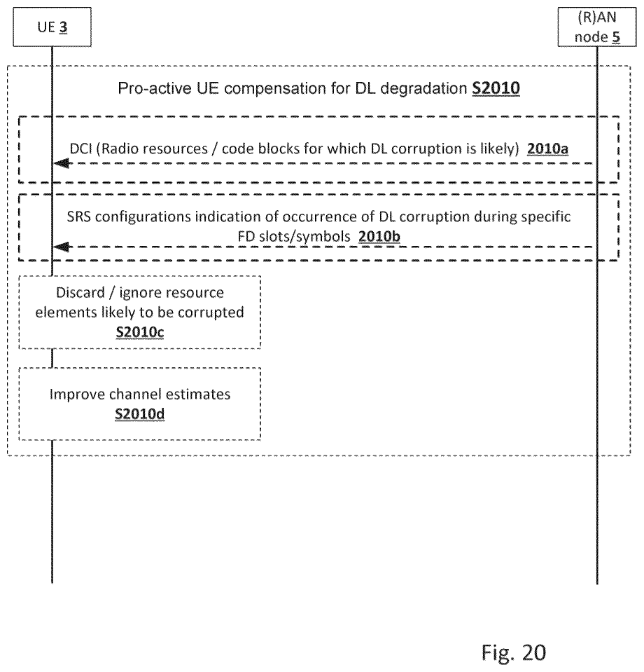

FIG. 19 is a simplified sequence diagram illustrating a number of possible interference alleviation/avoidance mechanisms based on robust decoding of the downlink that can be employed in the communication system 1.

As seen in FIG. 19 the interference alleviation/avoidance mechanisms include mechanisms based on the application of different code rates near the interference region (S1910) and on the provision of a higher density of downlink reference signals (RS) where interference may be expected (S1912).

It will be appreciated that the application of a better DL coding rate near the UL portion allows more robust decoding and increases the robustness of PDSCH transmissions which span higher radio resources as compared to the radio resources where interference is expected.

In order to facilitate this enhanced decoding, the base station 5 may indicate, to the UE 3, a different resource specific coding rate (or set of coding rates), that will be applied for a PDSCH transmission corresponding to specific resources or groups of resources, than the coding rate(s) that will be applied elsewhere (as indicated at S1910a). The coding rate(s) applicable for the radio resources where interference is expected may, for example, be lower than the coding rate(s) applied elsewhere to provide for more redundancy.

For example, the base station may indicate the different coding rate(s) in association with information identifying the associated resources (e.g. a subset of code words, or code block groups, or Oa subset of frequency and time resources allocated for the PDSCH) for which the different coding rate(s) is/are applicable. The information indicating the different coding rate(s) may be provided, for example, in DCI (e.g. using a scheduling DCI format).

Thus, when a PDSCH encoded on the resources to which the enhanced resource specific coding rate applies, using that enhanced coding rate, is sent to the UE 3 (at S1910b), the UE 3 can decode PDSCH appropriately based on that enhanced resource specific coding rate (at S1910c).

In a variation on this the network may divide a single DL transmission into two separate transport blocks TBs (separated in frequency) for transmission to the UE 3, where the TB closer to the resources configured for the UL have a better (lower) coding rate applied (as seen at S1910e). The applicable TB specific PDSCH coding rate(s) may be signalled to the UE 3 (as indicated at S1910d), for example using DCI.

Thus, when the two TBs of the PDSCH transmission arrive at the UE 3 (at S1910b), the UE 3 can decode each TB appropriately based on applicable coding rate for that TB (at S1910f).

This mechanism assumes that the UE 3 is able to receive two TBs, at the same time from same cell, belonging to different frequency regions. This may be facilitated, for example, by the UE 3 being configured to be able to decode multiple DCIs for a PDSCH in same search space occasion.

In another interference alleviation/avoidance mechanism illustrated in FIG. 19, the density of downlink reference signals (e.g. demodulation reference signals (DM-RS) and/or positioning reference signals (P-RS)) increased around the radio resources where interference is expected from the UL (as indicated at S1912).

To inform the UE 3 of the increased density, the base station 5 may provide configuration signalling (e.g. using RRC signalling) which indicates the density of RS with respect to frequency resources. The base station 5 may, alternatively of additionally, dynamically configure and/or activate/deactivate additional RS resources for the UE 3, that are near to the UL resources when needed (as indicated at S1912a).

Thus, the UE 3 can decode PDSCH appropriately, taking account of the enhanced RS density (e.g. for improving channel estimates, channel delay measurements) at S1912b.

### Pro-Active UE Compensation for DL Degradation

In order to alleviate the impact of interference, assistance information may be provided to the UE 3 to indicate where possible degradation of DL signals may occur to allow the UE 3 to pro-actively compensate accordingly.

FIG. 20 is a simplified sequence diagram illustrating a number of possible interference alleviation/avoidance mechanisms based on such proactive compensation for downlink degradation that can be employed in the communication system of FIG. 1.

As seen in FIG. 20, the base station 5 may, for example, provide assistance information in the form of an indication (e.g. via DCI) that a PDSCH transmission is likely to be corrupted for a specific subset of radio resources, together with information identifying thee affected radio resources or code blocks (as indicated at S2010a).

The base station 5 may, alternatively or additionally, provide assistance information in the form of an indication SRS configurations which can be interpreted by the UE 3, to indicate the occurrence of DL corruption during FD slots/symbols (as indicated at S2010b). The base station 5 may, for example, configure zero power SRS resources specific to FD slots/symbols where corruption is likely. The base station 5 may also provide an indication of the DL beam/TCI state information, per SRS occasion.

The UE 3 can determine based on the SRC configuration, the FD time occasions corresponding to the configured SRS occasions. The UE 3 can also restrict the FD time occasions by only considering the FD time occasions corresponding to DL beams/TCI state of the SRS occasions which match (or are close to) the DL beam/TCI state of UE 3.

The UE 3, after determining the time occasions, can take steps to alleviate any corruption. For example, the UE 3 may discard resource elements (REs) which are likely to be corrupted (e.g. CSI-RS REs may be discarded) (as indicated at S2010c), and/or may improve channel estimates based on the assistance information (as indicated at S2010c).

### User Equipment

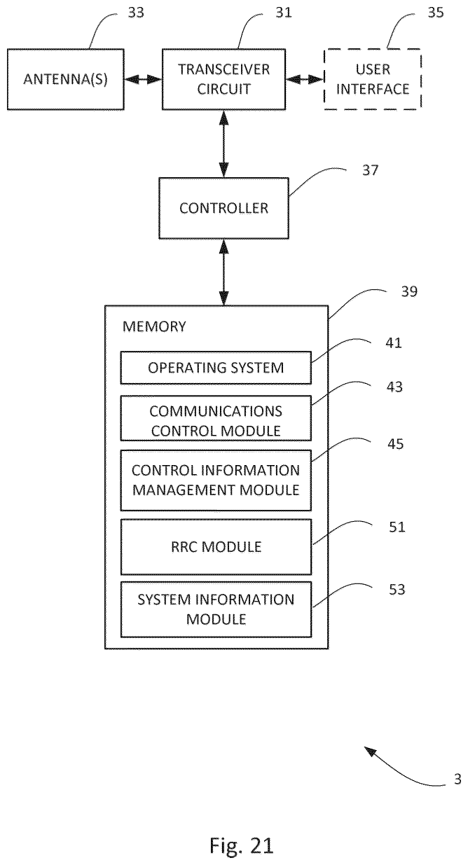

FIG. 21 is a schematic block diagram illustrating the main components of a UE 3 as shown in FIG. 2.

As shown, the UE 3 has a transceiver circuit 31 that is operable to transmit signals to and to receive signals from a base station 5 via one or more antenna 33. The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software and firmware, as appropriate. Software may be pre-installed in the memory 39 and/or may be downloaded via the telecommunications network or from a removable data storage device (RMD), for example.

The controller 37 is configured to control overall operation of the UE 3 by, in this example, program instructions or software instructions stored within memory 39. As shown, these software instructions include, among other things, an operating system 41, a communications control module 43, a control information management module 45, an RRC module 51, and a system information module 53.

The communications control module 43 is operable to control the communication between the UE 3 and its serving base station(s) 5 (and other communication devices connected to the base station 5, such as further UEs and/or core network nodes). The communications control module 43 is configured for the overall handling uplink communications via associated uplink channels (e.g. via a physical uplink control channel (PUCCH) and/or a physical uplink shared channel (PUSCH)) including both dynamic and semi-static signalling (e.g., SRS). The communications control module 43 is also configured for the overall handling receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 43 is responsible for determining the resources to be used by the UE 3, to determine how slots/symbols are configured (e.g., for UL, DL or FD communication, or the like), to determine which bandwidth part(s) are configured for the UE 3, and to control the implementation of one or more of the interference avoidance/alleviation mechanisms described.

The control information management module 45 is responsible for managing the tasks related to the reception of downlink control information from the base station.

The RRC module 51 is responsible for the reception of RRC signalling from the base station 5, and the transmission of RRC signalling to the base station 5.

The system information module 53 is responsible for the reception of system information from the base station 5.

### Base Station

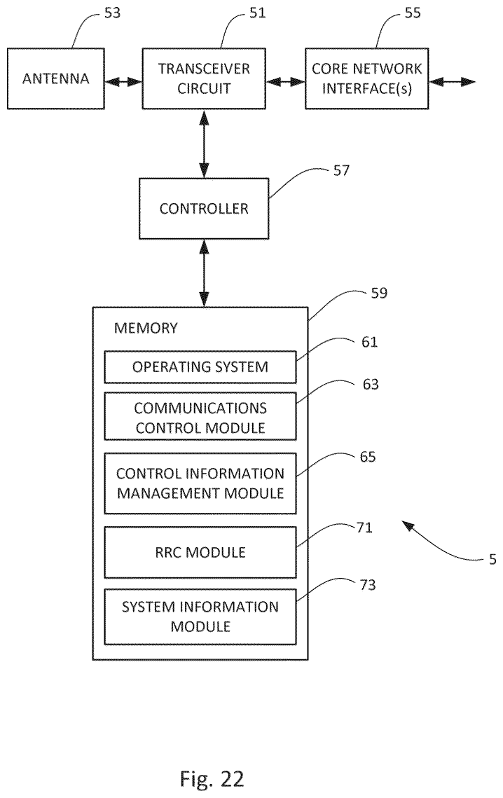

FIG. 22 is a schematic block diagram illustrating the main components of the base station 5 for the communication system 1 shown in FIG. 2. As shown, the base station 5 has a transceiver circuit 51 for transmitting signals to and for receiving signals from the communication devices (such as UEs 3) via one or more antenna 53 (e.g. an antenna array/massive antenna), and a core network interface 55 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 57 to control the operation of the base station 5. The controller 57 is associated with a memory 59. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within memory 59.

As shown, these software instructions include, among other things, an operating system 61, a communications control module 63, a control information management module 65, an RRC module 71, and a system information module 73.

The communications control module 63 is operable to control the communication between the base station 5 and UEs 3 and other network entities that are connected to the base station 5. The communications control module 63 is configured for the overall control of the reception of uplink communications, via associated uplink channels (e.g. via a physical uplink control channel (PUCCH) and/or a physical uplink shared channel (PUSCH)) including both dynamic and semi-static signalling (e.g., SRS). The communications control module 43 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS).

The control information management module 65 is responsible for managing the tasks related to the transmission of downlink control information from the base station.

The RRC module 71 is responsible for the reception of RRC signalling from UE 3, and the transmission of RRC signalling to the UE 3.

The system information module 73 is responsible for the transmission of system information to UEs in the base station's cell(s) 9.

### Modifications and Alternatives

A detailed example embodiment has been described above. As those skilled in the art will appreciate, a number of modifications and alternatives can be made to the above example embodiments whilst still benefiting from the disclosures embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

It can be seen, in broad terms, that in one example described a method is performed by a user equipment (UE), the method comprising: receiving, from an access network node: first information indicating, for a plurality of time resources, at least one of: which time resources of the plurality of time resources are configured for uplink communication and which time resources of the plurality of time resources are configured for downlink communication; and second information for configuring communication, in the plurality of time resources, in a first frequency region; configuring, based on the second information, a bandwidth of the first frequency region to provide, for a corresponding time resource of the plurality of time resources, a frequency gap between the first frequency region and a corresponding second frequency region that is adjacent (neighbours) the first frequency region in frequency; and communicating with the access network node in the first frequency region for each of the plurality of time resources.

It can be seen that in another example described a complementary method is performed by an access network node, the method comprising: transmitting, to a user equipment (UE): first information indicating, for a plurality of time resources, at least one of: which time resources of the plurality of time resources are configured for uplink communication and which time resources of the plurality of time resources are configured for downlink communication; and second information for configuring communication, in the plurality of time resources, in a first frequency region, wherein the second information includes information for application at the UE to configure, based on the second information, a bandwidth of the first frequency region to provide, for a corresponding time resource of the plurality of time resources, a frequency gap between the first frequency region and a corresponding second frequency region that is adjacent (neighbours) the first frequency region in frequency; and communicating with the UE in the first frequency region for each of the plurality of time resources.

The second information may include information indicating at least one time resource, of the plurality of time resources, for which the bandwidth of the first frequency region is to be reduced. The second information may include information indicating at least one of: that a bandwidth of at least one time resource is to be reduced from a higher frequency part of the first frequency region; that the bandwidth of the at least one time resource is to be reduced from a lower frequency part of the first frequency region; or that the bandwidth of the at least one time resource is to be reduced both from the higher frequency part of the first frequency region and the lower frequency part of the first frequency region. The second information may identify at least one time resource, of the plurality of time resources, that is to be used for full duplex communication.

The configuring may include configuring a reduced bandwidth, for at least one time resource that the second information indicates is to be used for full duplex communication, relative to the bandwidth of the first frequency region for at least one other time resource of the plurality of time resources.

The second information may configure at least one time resource of the plurality of time resources for downlink communication, and, in a case where the first information indicates that the at least one time resource of the plurality of time resources that the second information configures for downlink communication is configured for uplink communication, the configuring may include configuring a reduced bandwidth relative to the bandwidth of the first frequency region for at least one other time resource of the plurality of time resources.

The second information may configure at least one time resource of the plurality of time resources for uplink communication, and, in a case where the first information indicates that the at least one time resource of the plurality of time resources that the second information configures for uplink communication is configured for downlink communication, the configuring may include configuring a reduced bandwidth relative to the bandwidth of the first frequency region for at least one other time resource of the plurality of time resources.

The second information may configure at least one time resource of the plurality of time resources for downlink communication in the first frequency region and for uplink communication in the second frequency region, and, the configuring may include configuring the bandwidth of both the first frequency region and the second frequency region to provide, for the at least one other time resource of the plurality of time resources configured for downlink communication in the first frequency region and for uplink communication in the second frequency region, the frequency gap between the first operational bandwidth of the first frequency region and the second operational bandwidth of the corresponding second frequency region.

The configuring may be performed by reducing the bandwidth of the first frequency region, for at least one time resource of the plurality of time resources, at both a higher frequency edge and a lower frequency edge of the first frequency region.

The second information may indicate a size of the frequency gap that is to be provided by the configuring the bandwidth, or an amount by which the bandwidth of the first frequency region is to be reduced.

The second information may provide a resource allocation for a time resource of the plurality of time resources, and the configuring may include configuring a bandwidth for the time resource for which the resource allocation is provided depending on the first information.

In a case where the resource allocation is an uplink resource allocation and the first information indicates the time resource for which the resource allocation is provided is configured for downlink communication, the configuring may include configuring a reduced bandwidth for the time resource for which the resource allocation is provided, relative to the bandwidth of the first frequency region for at least one other time resource of the plurality of time resources.

In a case where the resource allocation is a downlink resource allocation and the first information indicates the time resource for which the resource allocation is provided is configured for uplink communication, the configuring may include configuring a reduced bandwidth for the time resource for which the resource allocation is provided, relative to the bandwidth of the first frequency region for at least one other time resource of the plurality of time resources.

In a case where the first information does not indicate that a time resource for which the resource allocation is provided is configured either for downlink or for uplink communication, the configuring may include configuring a reduced bandwidth for the time resource for which the resource allocation is provided, relative to the bandwidth of the first frequency region for at least one other time resource of the plurality of time resources.

The second information may include third information indicating a frequency configuration of the first frequency region that is to be applied to provide the frequency gap between the operational bandwidth of the first frequency region and the operational bandwidth of the corresponding second frequency region.

The third information may indicate a different frequency configuration is to be applied for time resources that are configured for uplink communication, than for time resources that are configured for downlink communication.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

| Service | MTC |
|---|---|
| Area | applications |
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VOLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Various other modifications will be apparent to those skilled in the art and will not be described in further detail here.

The whole or part of the exemplary embodiments disclosed above can be described as, but not limited to, the following supplementary notes.

### (Supplementary Note 1)

A method performed by a user equipment (UE), the method comprising: receiving, from an access network node:
first information indicating, for a plurality of time resources, at least one of:
which time resources of the plurality of time resources are configured for uplink communication, and
which time resources of the plurality of time resources are configured for downlink communication; and
second information for configuring communication, in the plurality of time resources, in a first frequency region;
configuring, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and
communicating with the access network node in the first operational bandwidth of the first frequency region for each of the plurality of time resources.

### (Supplementary Note 2)

The method according to Supplementary note 1, wherein the second information includes information indicating at least one time resource, of the plurality of time resources, for which the first operational bandwidth of the first frequency region is to be reduced.

### (Supplementary Note 3)

The method according to Supplementary note 1 or 2, wherein the second information includes information indicating at least one of:
that the first operational bandwidth of at least one time resource is to be reduced from a higher frequency part of the first frequency region;
that the first operational bandwidth of the at least one time resource is to be reduced from a lower frequency part of the first frequency region; or
that the first operational bandwidth of the at least one time resource is to be reduced both from the higher frequency part of the first frequency region and the lower frequency part of the first frequency region.

### (Supplementary Note 4)

The method according to any of Supplementary notes 1 to 3, wherein the second information identifies at least one time resource, of the plurality of time resources, that is to be used for full duplex communication.

### (Supplementary Note 5)

The method according to Supplementary note 4, wherein the configuring includes configuring a reduced bandwidth, for at least one time resource that the second information indicates is to be used for full duplex communication, relative to the first operational bandwidth of the first frequency region for at least one other time resource of the plurality of time resources.

### (Supplementary Note 6)

The method according to any of Supplementary notes 1 to 5, wherein
the second information configures at least one time resource of the plurality of time resources for downlink communication, and,
in a case where the first information indicates that the at least one time resource of the plurality of time resources that the second information configures for downlink communication is configured for uplink communication, the configuring includes configuring a reduced bandwidth relative to the first operational bandwidth of the first frequency region for at least one other time resource of the plurality of time resources.

### (Supplementary Note 7)

The method according to any of Supplementary notes 1 to 6, wherein the second information configures at least one time resource of the plurality of time resources for uplink communication, and,
in a case where the first information indicates that the at least one time resource of the plurality of time resources that the second information configures for uplink communication is configured for downlink communication, the configuring includes configuring a reduced bandwidth relative to the first operational bandwidth of the first frequency region for at least one other time resource of the plurality of time resources.

### (Supplementary Note 8)

The method according to any of Supplementary notes 1 to 7, wherein
the second information configures at least one time resource of the plurality of time resources for downlink communication in the first frequency region and for uplink communication in the corresponding second frequency region, and,
the configuring includes configuring the bandwidth of both the first frequency region and the corresponding second frequency region to provide, for the corresponding time resource of the plurality of time resources configured for downlink communication in the first frequency region and for uplink communication in the corresponding second frequency region, the at least one frequency gap part corresponding to the first operational bandwidth of the first frequency region and the second operational bandwidth of the corresponding second frequency region.

### (Supplementary Note 9)

The method according to any of Supplementary notes 1 to 8, wherein the configuring is performed by reducing the first operational bandwidth of the first frequency region, for at least one time resource of the plurality of time resources, at both a higher frequency edge and a lower frequency edge of the first frequency region.

### (Supplementary Note 10)

The method according to any of Supplementary notes 1 to 9, wherein the second information indicates a size of the at least one frequency gap part that is to be provided by the configuring the bandwidth, or an amount by which the first operational bandwidth of the first frequency region is to be reduced.

### (Supplementary Note 11)

The method according to any of Supplementary notes 1 to 10, wherein the second information provides a resource allocation for a time resource of the plurality of time resources, and the configuring includes configuring a reduced bandwidth for the time resource for which the resource allocation is provided depending on the first information.

### (Supplementary Note 12)

The method according to Supplementary note 11, wherein:
in a case where the resource allocation is an uplink resource allocation and the first information indicates the time resource for which the resource allocation is provided is configured for downlink communication, the configuring includes configuring the reduced bandwidth for the time resource for which the resource allocation is provided, relative to the first operational bandwidth of the first frequency region for at least one other time resource of the plurality of time resources; and
in a case where the resource allocation is a downlink resource allocation and the first information indicates the time resource for which the resource allocation is provided is configured for uplink communication, the configuring includes configuring the reduced bandwidth for the time resource for which the resource allocation is provided, relative to the first operational bandwidth of the first frequency region for at least one other time resource of the plurality of time resources.

### (Supplementary Note 13)

The method according to Supplementary note 11 or 12, wherein:
in a case where the first information does not indicate that a time resource for which the resource allocation is provided is configured either for downlink or for uplink communication, the configuring includes configuring the reduced bandwidth for the time resource for which the resource allocation is provided, relative to the first operational bandwidth of the first frequency region for at least one other time resource of the plurality of time resources.

### (Supplementary Note 14)

The method according to any of Supplementary notes 1 to 13, wherein the second information includes third information indicating a frequency configuration of the first frequency region that is to be applied to provide the at least one frequency gap part corresponding to the first operational bandwidth of the first frequency region and the second operational bandwidth of the corresponding second frequency region.

### (Supplementary Note 15)

The method according to Supplementary note 14, wherein the third information indicates a different frequency configuration is to be applied for time resources that are configured for uplink communication, than for time resources that are configured for downlink communication.

### (Supplementary Note 16)

A method performed by a user equipment (UE), the method comprising: receiving, from an access network node, signalling including indication information for indicating at least one time resource, of a plurality of time resources, that is to be used for full duplex communication;
determining, based on the indication information, resources within the at least one time resource, for which at least part of at least one uplink transmission is not to take place, or for which at least part of at least one downlink transmission will not be transmitted; and communicating with the access network node based on the determining.

### (Supplementary Note 17)

The method according to Supplementary note 16, wherein the at least part of the at least one uplink transmission is at least one semi-static uplink transmission, and the at least part of at least one downlink transmission is at least one semi-static downlink transmission.

### (Supplementary Note 18)

The method according to Supplementary note 16 or 17, wherein the at least part of the at least one uplink transmission is at least one dynamic uplink transmission, and the at least part of the at least one downlink transmission is at least one dynamic downlink transmission.

### (Supplementary Note 19)

The method according to Supplementary note 18, further comprising:
receiving semi-static signalling configuration information for configuring semi-static signalling, wherein
the determining includes determining, based on the semi-static signalling configuration information:
that at least one dynamic uplink transmission is not to take place during at least part of at least one downlink semi-static signalling occasion that occurs within the at least one time resource that is to be used for full duplex communication, or
that at least one dynamic downlink transmission is not to take place during at least part of at least one uplink semi-static signalling occasion that occurs within the at least one time resource that is to be used for full duplex communication.

### (Supplementary Note 20)

The method according to any of Supplementary notes 16 to 19, further comprising receiving, from the access network node, rate-matching resource information indicating rate-matching resources around which rate-matching of the dynamic uplink transmission, or the dynamic downlink transmission, is to be performed.

### (Supplementary Note 21)

The method according to Supplementary note 20, wherein the rate-matching resource information indicates time resources in which a rate matching pattern is to be applied.

### (Supplementary Note 22)

The method according to Supplementary note 20 or 21, wherein the rate-matching resource information identifies a different respective rate matching pattern for each of a plurality of transmission configuration indicator (TCI) states, or for each of a plurality of downlink beams.

### (Supplementary Note 23)

The method according to any of Supplementary notes 20 to 22, wherein the rate-matching resource information indicates at least one downlink semi-static signalling resource configuration where uplink rate matching is to be performed, or at least one uplink semi-static signalling resource configuration where downlink rate matching is to be performed.

### (Supplementary Note 24)

The method according to any of Supplementary notes 16 to 23, wherein the determining includes determining that at least part of at least one uplink transmission is not to take place in a time resource that is to be used for full duplex communication, or that at least one part of at least downlink transmission will not be transmitted in a time resource that is to be used for full duplex communication.

### (Supplementary Note 25)

The method according to any of Supplementary notes 16 to 18, wherein the indication information indicates a time resource is to be used for full duplex communication by indicating that the time resource includes both uplink and downlink information.

### (Supplementary Note 26)

The method according to any of Supplementary notes 16 to 25, further comprising receiving time resource configuration information indicating, for the plurality of time resources, which time resources of the plurality of time resources are configured for uplink communication and which time resources of the plurality of time resources are configured for downlink communication.

### (Supplementary Note 27)

The method according to Supplementary note 26, wherein the indication information indicates a time resource is to be used for full duplex communication:
by indicating that the time resource is an uplink time resource in a case where that time resource is indicated to be configured for downlink communication by the time resource configuration information; and
by indicating that the time resource is a downlink time resource in a case where that time resource is indicated to be configured for uplink communication by the time resource configuration information.

### (Supplementary Note 28)

The method according to Supplementary note 26 or 27, wherein the determining includes determining, based on the time resource configuration information:
that at least part of at least one uplink transmission in a time resource that is to be used for full duplex communication is not to take place unless the time resource configuration information indicates that that time resource is configured for uplink communication, or
that at least part of at least one downlink transmission will not be transmitted in a time resource that is to be used for full duplex communication, unless the time resource configuration information indicates that that time resource is configured for downlink communication.

### (Supplementary Note 29)

The method according to any of Supplementary notes 16 to 28, wherein the signalling includes frequency region information identifying a frequency region to be used for uplink communication and a frequency region to be used for downlink communication.

### (Supplementary Note 30)

The method according to Supplementary note 28, wherein the determining includes determining, based on the frequency region information:
that at least part of at least one uplink transmission is not to take place if a resource bandwidth for the at least part of at least one uplink transmission extends beyond a bandwidth of the frequency region to be used for uplink communication, or
that at least part of at least one downlink transmission will not be transmitted if a resource bandwidth for the at least part of at least one downlink transmission extends beyond a bandwidth of the frequency region to be used for downlink communication.

### (Supplementary Note 31)

The method according to Supplementary note 30, further comprising:
receiving a plurality of different resource configurations for uplink communication, wherein
in a case where the determining includes determining at least part of at least one uplink transmission is not to take place because a resource bandwidth for the at least one uplink transmission extends beyond the bandwidth of the frequency region to be used for uplink communication, the determining includes determining a resource configuration of the plurality of different resource configurations that is within the bandwidth of the frequency region to be used for uplink communication to use for the at least part of at least one uplink transmission.

### (Supplementary Note 32)

The method according to any of Supplementary notes 16 to 31, wherein the signalling includes information indicating at least one frequency gap part that is to be applied to a frequency region to be used for uplink communication and a frequency region to be used for downlink communication.

### (Supplementary Note 33)

The method according to any of Supplementary notes 16 to 32, wherein the signalling includes beam information indicating at least one beam for which uplink transmission is not to take place, or where at least part of at least one downlink transmission will not be transmitted.

### (Supplementary Note 34)

The method according to Supplementary note 33, wherein the determining includes determining, based on the beam information:

that at least part of at least one uplink transmission is not to take place in a case where the UE is connected to the access network node via a beam for which uplink transmission is not to take place, or
that at least part of at least one downlink transmission will not be transmitted in a case where the UE is connected to the access network node via a beam for which downlink transmission will not be transmitted.

### (Supplementary Note 35)

The method according to any of Supplementary notes 16 to 34, wherein the determining includes determining:

that at least part of at least one uplink transmission is not to take place in a time resource based on a priority of the at least one uplink transmission, or
that at least part of at least one downlink transmission will not be transmitted in a time resource based on a priority of the at least part of at least one downlink transmission.

### (Supplementary Note 36)

A method performed by a user equipment (UE), the method comprising:
receiving, from an access network node, information for indicating a modification to at least one frequency resource allocation for semi-static signalling to be applied in at least one time resource, of a plurality of time resources, that is to be used for full duplex communication; and
transmitting or receiving the semi-static signalling, using at least one frequency resource allocation as modified by the modification, in the at least one time resource that is to be used for full duplex communication.

### (Supplementary Note 37)

The method according to Supplementary note 36, wherein the information for indicating a modification indicates at least one frequency resource allocation that allocates different frequency resources than frequency resources used for the semi-static signalling in at least one other time resource, of a plurality of time resources.

### (Supplementary Note 38)

The method according to Supplementary note 36 or 37, wherein
the at least one frequency resource allocation includes a plurality of frequency regions, and
the information for indicating a modification indicates that at least one frequency region of the plurality of frequency is to be activated or deactivated during the at least one time resource.

### (Supplementary Note 39)

A method performed by a user equipment (UE), the method comprising:
receiving, from an access network node information for assisting enhanced decoding of downlink information in a first part of a first frequency region compared to a second part of the first frequency region,
wherein the first frequency region is configured for downlink communication in at least one time resource that is configured as a full duplex time resource, and wherein the first part of the first frequency region is closer in frequency, than the second part of the first frequency region, to a second frequency region configured for uplink communication in the at least one time resource that is configured as a full duplex time resource; and
decoding downlink communication in the first part of the first frequency region and in the second part of the first frequency region, wherein the first part of the first frequency region is decoded based on the information for assisting enhanced decoding of downlink information.

### (Supplementary Note 40)

The method according to Supplementary note 39, wherein the information for assisting enhanced decoding of downlink information includes a coding rate to be used for downlink communication in the first part of the first frequency region that is different to a coding rate to be used for downlink communication in the second part of the first frequency region.

### (Supplementary Note 41)

The method according to Supplementary note 39 or 40, wherein the information for assisting enhanced decoding of downlink information includes information identifying an increased reference signal density in the first part of the first frequency region compared to the second part of the first frequency region.

### (Supplementary Note 42)

The method according to any of Supplementary notes 39 to 41, wherein the information for assisting enhanced decoding of downlink information includes information indicating to the UE that degradation of downlink signals is more likely in the first part of the first frequency region compared to the second part of the first frequency region.

### (Supplementary Note 43)

The method according to any of Supplementary notes 39 to 42, wherein decoding downlink communication in the first part of the first frequency region includes discarding contributions from resource elements based on the information for assisting enhanced decoding of downlink information.

### (Supplementary Note 44)

The method according to any of Supplementary notes 39 to 43, wherein decoding downlink communication in the first part of the first frequency region includes enhancing channel estimates based on the information for assisting enhanced decoding of downlink information.

### (Supplementary Note 45)

A user equipment (UE) comprising:
means for receiving, from an access network node:
first information indicating, for a plurality of time resources, at least one of:
which time resources of the plurality of time resources are configured for uplink communication, and
which time resources of the plurality of time resources are configured for downlink communication; and
second information for configuring communication, in the plurality of time resources, in a first frequency region; and
means for configuring, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and
means for communicating with the access network node in the first operational bandwidth of the first frequency region for each of the plurality of time resources.

### (Supplementary Note 46)

A user equipment (UE) comprising:
means for receiving, from an access network node signalling including indication information for indicating at least one time resource, of a plurality of time resources, that is to be used for full duplex communication;
means for determining, based on the indication information, resources within the at least one time resource that is to be used for full duplex communication, for which at least part of at least one uplink transmission is not to take place, or for which at least part of at least one downlink transmission will not be transmitted; and
means for communicating with the access network node based on the determining.

### (Supplementary Note 47)

A user equipment (UE) comprising:
means for receiving, from an access network node information for indicating a modification to at least one frequency resource allocation for semi-static signalling to be applied in at least one time resource, of a plurality of time resources, that is to be used for full duplex communication; and
means for transmitting or receiving the semi-static signalling, using at least one frequency resource allocation as modified by the modification, in the at least one time resource that is to be used for full duplex communication.

### (Supplementary Note 48)

A user equipment (UE) comprising:
means for receiving, from an access network node information for assisting enhanced decoding of downlink information in a first part of a first frequency region compared to a second part of the first frequency region,
wherein the first frequency region is configured for downlink communication in at least one time resource that is configured as a full duplex time resource, and
wherein the first part of the first frequency region is closer in frequency, than the second part of the first frequency region, to a second frequency region configured for uplink communication in the at least one time resource that is configured as a full duplex time resource; and
means for decoding downlink communication in the first part of the first frequency region and in the second part of the first frequency region, wherein the first part of the first frequency region is decoded based on the information for assisting enhanced decoding of downlink information.

### (Supplementary Note 49)

A method performed by an access network node, the method comprising:
transmitting, to a user equipment (UE):
first information indicating, for a plurality of time resources, at least one of:
which time resources of the plurality of time resources are configured for uplink communication, and
which time resources of the plurality of time resources are configured for downlink communication; and
second information for configuring communication, in the plurality of time resources, in a first frequency region,
wherein the second information includes information for application at the UE to configure, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and
communicating with the UE in the first operational bandwidth of the first frequency region for each of the plurality of time resources.

### (Supplementary Note 50)

A method performed by an access network node, the method comprising:
transmitting, to a user equipment (UE) signalling including indication information for indicating at least one time resource, of a plurality of time resources, that is to be used for full duplex communication,
wherein the full duplex indication information includes information for application at the UE to determine, based on the indication information, resources within the at least one time resource that is to be used for full duplex communication, for which at least part of at least one uplink transmission is not to take place, or for which at least part of at least one downlink transmission will not be transmitted; and
communicating with the UE based on the full duplex indication information.

### (Supplementary Note 51)

A method performed by an access network node, the method comprising:
transmitting, to a user equipment (UE) information for indicating a modification to at least one frequency resource allocation for semi-static signalling to be applied in at least one time resource, of a plurality of time resources, that is to be used for full duplex communication; and
transmitting or receiving the semi-static signalling, using at least one frequency resource allocation as modified by the modification, in the at least one time resource that is to be used for full duplex communication.

### (Supplementary Note 52)

A method performed by an access network node, the method comprising:
transmitting, to a user equipment (UE) information for assisting enhanced decoding of downlink information in a first part of a first frequency region compared to a second part of the first frequency region,
wherein the first frequency region is configured for downlink communication in at least one time resource that is configured as a full duplex time resource,
wherein the first part of the first frequency region is closer in frequency, than the second part of the first frequency region, to a second frequency region configured for uplink communication in the at least one time resource that is configured as a full duplex time resource, and
wherein the full duplex indication information includes information for application at the UE to decode downlink communication in the first part of the first frequency region and in the second part of the first frequency region, wherein the first part of the first frequency region is decoded based on the information for assisting enhanced decoding of downlink information.

### (Supplementary Note 53)

An access network node comprising:
means for transmitting, to a user equipment (UE):
first information indicating, for a plurality of time resources, at least one of:
which time resources of the plurality of time resources are configured for uplink communication, and
which time resources of the plurality of time resources are configured for downlink communication; and
second information for configuring communication, in the plurality of time resources, in a first frequency region, wherein the second information includes information for application at the UE to configure, based on the second information, a bandwidth of the first frequency region to provide, for a corresponding time resource of the plurality of time resources, at least one frequency gap part corresponding to a first operational bandwidth of the first frequency region and a second operational bandwidth of a corresponding second frequency region; and
means for communicating with the UE in the first operational bandwidth of the first frequency region for each of the plurality of time resources.

### (Supplementary Note 54)

An access network node comprising:
means for transmitting, to a user equipment (UE) signalling including full duplex indication information for indicating at least one time resource, of a plurality of time resources, that is to be used for full duplex communication,
wherein the full duplex indication information includes information for application at the UE to determine, based on the full duplex indication information, resources within the at least one time resource that is to be used for full duplex communication, for which at least part of at least one uplink transmission is not to take place, or for which at least part of at least one downlink transmission will not be transmitted; and
means for communicating with the UE based on the full duplex indication information.

### (Supplementary Note 55)

An access network node comprising:
means for transmitting, to a user equipment (UE) information for indicating a modification to at least one frequency resource allocation for semi-static signalling to be applied in at least one time resource, of a plurality of time resources, that is to be used for full duplex communication; and
means for transmitting or receiving the semi-static signalling, using at least one frequency resource allocation as modified by the modification, in the at least one time resource that is to be used for full duplex communication.

### (Supplementary Note 56)

An access network node comprising:
means for transmitting, to a user equipment (UE) information for assisting enhanced decoding of downlink information in a first part of a first frequency region compared to a second part of the first frequency region,
wherein the first frequency region is configured for downlink communication in at least one time resource that is configured as a full duplex time resource, and
wherein the first part of the first frequency region is closer in frequency, than the second part of the first frequency region, to a second frequency region configured for uplink communication in the at least one time resource that is configured as a full duplex time resource, and
wherein the full duplex indication information includes information for application at the UE to decode downlink communication in the first part of the first frequency region and in the second part of the first frequency region, wherein the first part of the first frequency region is decoded based on the information for assisting enhanced decoding of downlink information.

This application is based upon and claims the benefit of priority from Britain Patent Application No. 2208069.1, filed on May 31, 2022, the disclosure of which is incorporated herein in its entirety by reference.

### REFERENCE SIGNS LIST

1 MOBILE TELECOMMUNICATION SYSTEM
3-1, 3-2, 3-3 USER EQUIPMENT
5 RADIO ACCESS NETWORK (RAN) NODE
7 CORE NETWORK
9 CELL
10 ACCESS AND MOBILITY MANAGEMENT FUNCTION (AMF)
11 USER PLANE FUNCTION (UPF)

What is claimed is:

1-50. (canceled)

51. A method performed by a user equipment (UE), the method comprising:
receiving, from an access network node, information for indicating at least one time resource that is to be used for full duplex communication;
selecting, based on the information, resources configuration corresponding to a type of the at least one time resource; and
adjusting communication with the access network node using the resource configuration based on the determining.

52. The method according to claim 51, wherein
in a case where each of communication occasions has either the at least one time resource or at least one further time resource that is not to be used for full duplex communication, resource configuration corresponding to another type of the at least one further time resource is used for determining frequency resources used for the communication.

53. The method according to claim 51, wherein
in a case where at least one of communication occasions is across both the at least one time resource and at least one further time resource that is not to be used for full duplex communication:
the communication is restricted on either the at least one time resource only or the at least one further time resource only, or
the communication can be on both the at least one time resource and the at least one further time resource.

54. The method according to claim 51, wherein
the resource configuration corresponding to the type of the at least one time resource and the resource configuration corresponding to the another type of the at least one further time resource both refer to common resources.

55. The method according to claim 51, further comprising:
receiving frequency location information for at least one of a uplink (UL) frequency region and a downlink (DL) frequency region for the at least one time resource to be used for full duplex communication.

56. The method according to claim 55, further comprising:
excluding at least one frequency resource outside resources indicated by the frequency location information, for the communication.

57. The method according to claim 56, wherein
in a case where the resources indicated by the frequency location information are across a boundary of the UL frequency region or the DL frequency region, the communication is restricted on the resources indicated by the frequency location information only.

58. The method according to claim 51, further comprising:
determining that:
at least part of at least one uplink transmission is not performed in a time resource that is to be used for full duplex communication, or
at least part of at least one downlink transmission is not performed in a time resource that is to be used for full duplex communication.

59. The method according to claim 51, further comprising:
determining:
that at least part of at least one uplink transmission in a time resource that is to be used for full duplex communication is not performed unless the resource configuration indicates that that time resource is configured for uplink communication, or
that at least part of at least one downlink transmission is not performed in a time resource that is to be used for full duplex communication, unless the resource configuration indicates that that time resource is configured for downlink communication.

60. The method according to claim 51, wherein
the information indicates a modification to at least one frequency resource allocation for semi-static signalling to be applied in at least one time resource that is to be used for full duplex communication, and
the adjusting includes communicating the semi-static signalling, using at least one frequency resource allocation as modified by the modification, in the at least one time resource that is to be used for full duplex communication.

61. The method according to claim 60, wherein
the information indicates at least one frequency resource allocation that allocates different frequency resources than frequency resources used for the semi-static signalling in at least one other time resource.

62. A user equipment (UE) comprising:
at least one memory storing instructions, and
at least one processor configured to execute the instructions to; receive, from an access network node, information for indicating at least one time resource that is to be used for full duplex communication;
select, based on the information, resources configuration corresponding to a type of the at least one time resource; and
adjust communication with the access network node using the resource configuration based on the determining.

63. A method performed by an access network node, the method comprising:
transmitting, to a user equipment (UE), information for indicating at least one time resource that is to be used for full duplex communication,
wherein the information is used by the UE to select resources configuration corresponding to a type of the at least one time resource; and
adjusting communication with the UE using the resource configuration based on the information.

64. An access network node comprising:
at least one memory storing instructions, and
at least one processor configured to execute the instructions to; transmit, to a user equipment (UE), information for indicating at least one time resource that is to be used for full duplex communication,
wherein the information is used by the UE to select resources configuration corresponding to a type of the at least one time resource; and
adjust communication with the UE using the resource configuration based on the information.
